(19) United States
(12) Patent Application Publication
(10) Pub. No.: US 2023/0297847 A1
(43) Pub. Date: Sep. 21, 2023

(54) MACHINE-LEARNING TECHNIQUES FOR FACTOR-LEVEL MONOTONIC NEURAL NETWORKS

(71) Applicant: EQUIFAX INC., Atlanta, GA (US)

(72) Inventors: Matthew TURNER, Cumming, GA (US); Stephen MILLER, Guiseley, Leeds (GB)

(21) Appl. No.: 18/006,384

(22) PCT Filed: Jul. 14, 2021
(86) PCT No.: PCT/US2021/041681

§ 371 Date: Jan. 20, 2023

Related U.S. Application Data
(60) Provisional application No. 63/054,448, filed on Jul. 21, 2020.

(51) Int. Cl. G06N 3/0985

(52) U.S. Cl. CPC G06N 3/0985

(57) ABSTRACT

In some aspects, a computing system can generate and optimize a neural network for risk assessment. Input predictor variables can be analyzed to identify common factors of these predictor variables. The neural network can be trained to enforce a monotonic relationship between each common factor of the input predictor variables and an output risk indicator. The training of the neural network can involve solving an optimization problem under this monotonic constraint. The optimized neural network can be used both for accurately determining risk indicators for target entities using predictor variables and determining explanation codes for the predictor variables. Further, the risk indicators can be utilized to control the access by a target entity to an interactive computing environment for accessing services provided by one or more institutions.

### CROSS-REFERENCE TO RELATED APPLICATIONS

This claims priority to U.S. Provisional Application No. 63/054,448, entitled “Machine-Learning Techniques for Factor-Level Monotonic Neural Networks,” filed on Jul. 21, 2020, which is hereby incorporated in its entirety by this reference.

### TECHNICAL FIELD

The present disclosure relates generally to artificial intelligence. More specifically, but not by way of limitation, this disclosure relates to machine learning using artificial neural networks for emulating intelligence that are trained for assessing risks or performing other operations and for providing explainable outcomes associated with these outputs.

### BACKGROUND

In machine learning, artificial neural networks can be used to perform one or more functions (e.g., acquiring, processing, analyzing, and understanding various inputs in order to produce an output that includes numerical or symbolic information). A neural network includes one or more algorithms and interconnected nodes that exchange data between one another. The nodes can have numeric weights that can be tuned based on experience, which makes the neural network adaptive and capable of learning. For example, the numeric weights can be used to train the neural network such that the neural network can perform the one or more functions on a set of input variables and produce an output that is associated with the set of input variables.

### SUMMARY

Various aspects of the present disclosure provide systems and methods for optimizing a factor-level monotonic neural network for risk assessment and outcome prediction. The factor-level monotonic neural network (also referred to as the “neural network” or the “monotonic neural network” in short) is trained to compute a risk indicator from predictor variables. In a trained factor-level monotonic neural network, each of the common factors of input predictor variables has a monotonic relationship with the output of the neural network. The monotonic neural network can be a memory structure comprising nodes connected via one or more layers. The training of the monotonic neural network involves accessing training vectors that have elements representing training predictor variables and training outputs. A particular training vector can include particular values for the corresponding predictor variables and a particular training output corresponding to the particular values of the predictor variables.

The training of the monotonic neural network further involves obtaining loading coefficients of common factors of the training predictor variables in the training vectors and performing iterative adjustments of parameters of the neural network model to minimize a loss function of the neural network model subject to a path constraint. The path constraint requires a monotonic relationship between each of the common factors of the predictor variables from the training vectors and the training outputs of the training vectors. The relationship between each of the common factors and the training outputs can be formulated using the loading coefficients of common factors and the parameters of the neural network model.

In some aspects, the optimized monotonic neural network can be used to predict risk indicators. For example, a risk assessment query for a target entity can be received from a remote computing device. In response to the assessment query, an output risk indicator for the target entity can be computed by applying the neural network to predictor variables associated with the target entity. Explanatory data indicating relationships between changes in the risk indicator and changes in at least some of the common factors can also be calculated using the neural network. A responsive message including at least the output risk indicator can be transmitted to the remote computing device.

This summary is not intended to identify key or essential features of the claimed subject matter, nor is it intended to be used in isolation to determine the scope of the claimed subject matter. The subject matter should be understood by reference to appropriate portions of the entire specification, any or all drawings, and each claim.

The foregoing, together with other features and examples, will become more apparent upon referring to the following specification, claims, and accompanying drawings.

### BRIEF DESCRIPTION OF THE DRAWINGS

FIG. 1 is a block diagram depicting an example of a computing environment in which a factor-level monotonic neural network can be trained and applied in a risk assessment application according to certain aspects of the present disclosure.

FIG. 2 is a flow chart depicting an example of a process for utilizing a neural network to generate risk indicators for a target entity based on predictor variables associated with the target entity according to certain aspects of the present disclosure.

FIG. 3 is a flow chart depicting an example of a process for training a factor-level monotonic neural network according to certain aspects of the present disclosure.

FIG. 4 is a diagram depicting an example of a multi-layer neural network that can be generated and optimized according to certain aspects of the present disclosure.

FIG. 5 is a block diagram depicting an example of a computing system suitable for implementing aspects of the techniques and technologies presented herein.

### DETAILED DESCRIPTION

Machine-learning techniques can involve inefficient expenditures or allocations of processing resources, a lack of desired performance or explanatory capability with respect to the applications of these machine-learning techniques, or both. In one example, the complicated structure of a neural network and the interconnections among the various nodes in the neural network can increase the difficulty of explaining relationships between an input variable and an output of a neural network. Monotonic neural networks can enforce monotonicity between input variables and output, thereby facilitate formulating explainable relationships between the input variables and the output. But training a monotonic neural network to provide this explanatory capability can be expensive with respect to, for example, processing resources, memory resources, network bandwidth, or other resources. This resource problem is especially prominent in cases where large training datasets are used for machine learning, which can result in a large number of the input variables, a large number of network layers, and a large number of neural network nodes in each layer. In addition, enforcing monotonicity between each input variable and the output limits the predictability of the neural network, thereby resulting in reduced prediction accuracy.

Certain aspects described herein for optimizing a factor-level monotonic neural network for risk assessment or other outcome predictions can address one or more issues identified above. For example, instead of requiring a monotonic relationship between each input variable and an output of the neural network (referred to as the “input-level monotonicity”), a factor-level monotonic neural network can maintain a monotonic relationship between each common factor of the input variables and an outcome or other output (referred to as “factor-level monotonicity”). For example, the monotonic relationship exists between a common factor and the output if a positive change in the common factor results in a positive change in the output or vice versa. Common factors can be determined from the predictor variables through factor analysis and represent the underlying variables or features of the predictor variables. The number of the common factors of a set of predictor variables is generally much lower than the number of the predictor variables. As such, multiple predictor variables may correspond to one common factor and may collectively determine the common factor. As a result, a monotonic relationship may exist between a common factor and the output even if there is no monotonic relationship between the predictor variables associated with the common factor and the output. In this way, the input-level monotonicity requirement imposed in a traditional monotonic neural network can be relaxed, thereby increasing the predictability of the neural network and thus the prediction accuracy.

The factor-level monotonicity is useful to evaluate the impact of input variables on the output. For example, in risk assessment, the monotonic relationship between each common factor of the input variables and the output risk indicator can be utilized to explain the outcome of the prediction and to provide explanatory data for the predictor variables that are associated with the common factor. The explanatory data indicate an effect or an amount of aggregated impact that the predictor variables associated with a given common factor have on the risk indicator.

To ensure the factor-level monotonicity of a neural network, the training of the neural network can be formulated as solving a constrained optimization problem in some examples. The goal of the optimization problem is to identify a set of optimized weights for the neural network so that a loss function of the neural network is minimized under a constraint that the relationship between each common factor of the input variables and the output is monotonic. To reduce the computational complexity of the optimization problem, thereby saving computational resources, such as CPU times and memory spaces, the constrained neural network can be approximated by an unconstrained optimization problem. The unconstrained optimization problem can be formulated by introducing a Lagrangian multiplier and by approximating the monotonicity constraint using a smooth differentiable function.

In another example, the training of the factor-level monotonic neural network can be performed by identifying a transform matrix by decomposing a loading matrix of the common factors of the training predictor variables. The input predictor variables are transformed by applying the transform matrix before fed into the neural network. During each iteration of the training, the weights of connections among the one or more hidden layers and the output layer that are negative can be set to zero. For weights of connections between the input layer and a first hidden layer, a subset of weights can be identified and negative weights in the subset of weights are set to zero. This ensures the monotonicity between the common factors and the output of the neural network.

The factor-level monotonic neural network benefits from a sparse factor loading matrix. To achieve such a goal, the factor analysis for identifying common factors and the loading matrix can be performed by applying a modified expectation-maximization (EM) algorithm. In this modified EM algorithm, the training server or another computing device can apply a least absolute shrinkage and selection operator (LASSO) regression on the training predictor variables and the common factors, instead of the least squares regression in the traditional EM algorithm. The LASSO regression introduces an L1 norm of the loading matrix of the common factors to a loss function of the maximization step. The training server or the other computing device can solve the maximization step by applying a closed-form solution of the LASSO regression.

Certain aspects described herein, which can include operations and data structures with respect to neural networks that improve how computing systems service analytical queries, can overcome one or more of the issues identified above. For instance, the neural network presented herein is structured so that a monotonic relationship exists between each common factor of the input variables and the output. Structuring such a factor-based monotonic neural network can include enforcing the neural network, such as through the weights of the connections between network nodes, to provide monotonic paths from each common factor of the inputs to the outputs. Such a structure can improve the operations of the neural network by eliminating post-training adjustment of the neural network for monotonicity property, and allowing using the same neural network to predict an outcome and to generate explainable reasons for the predicted outcome. In addition, the factor-level monotonicity requirement relaxes the input-level monotonicity requirement imposed in a traditional monotonic neural network, which maintains the interpretability of the neural network while increasing the predictability (and thus the prediction accuracy) of the neural network. As a result, access control decisions or other types of decisions made based on the predictions generated by the neural network are more accurate. Further, the interpretability of the neural network makes these decisions explainable and allows entities to improve their respective attributes thereby obtaining desired access control decisions or other decisions.

Additional or alternative aspects can implement or apply rules of a particular type that improve existing technological processes involving machine-learning techniques. For instance, to enforce the factor-level monotonicity of the neural network, a particular set of rules are employed in the training of the neural network. This particular set of rules allow the monotonicity to be introduced as a constraint in the optimization problem involved in the training of the neural network, which allows the training of the monotonic neural network to be performed more efficiently without any post-training adjustment. Furthermore, additional rules can be introduced in training the neural network to further increase the efficiency of the training, such as rules for adjusting the parameters of the neural network, rules for regularizing overfitting of the neural network, rules for stabilizing the neural network, or rules for simplifying the structure of the neural network. The particular rules can enable training the neural network to be performed efficiently. For example, training can be completed faster and requiring fewer computational resources, and effectively, resulting in the trained neural network being stable, reliable, and monotonic for providing explainable prediction.

These illustrative examples are given to introduce the reader to the general subject matter discussed here and are not intended to limit the scope of the disclosed concepts. The following sections describe various additional features and examples with reference to the drawings in which like numerals indicate like elements, and directional descriptions are used to describe the illustrative examples but, like the illustrative examples, should not be used to limit the present disclosure.

### Operating Environment Example for Machine-Learning Operations

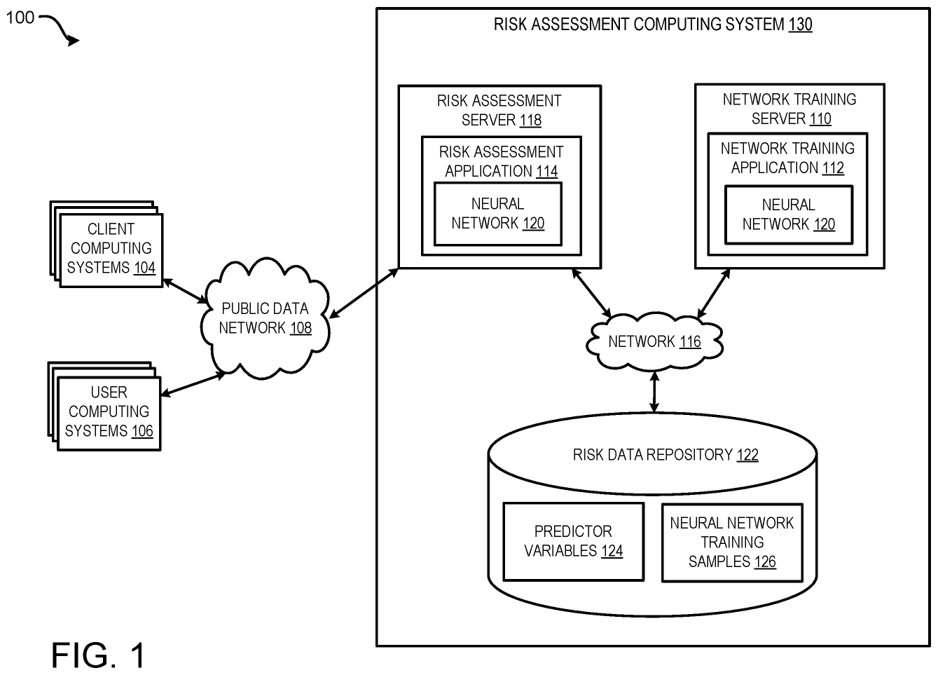

Referring now to the drawings, FIG. 1 is a block diagram depicting an example of an operating environment 100 in which a risk assessment computing system 130 builds and trains a monotonic neural network that can be utilized to predict risk indicators based on predictor variables. FIG. 1 depicts examples of hardware components of a risk assessment computing system 130, according to some aspects. The risk assessment computing system 130 is a specialized computing system that may be used for processing large amounts of data using a large number of computer processing cycles. The risk assessment computing system 130 can include a network training server 110 for building and training a factor-level monotonic neural network 120 (or neural network 120 in short) wherein each of the common factors of the input predictor variables of the neural network 120 has a monotonic relationship with the output of the neural network 120. The risk assessment computing system 130 can further include a risk assessment server 118 for performing a risk assessment for given predictor variables 124 using the trained neural network 120.

The network training server 110 can include one or more processing devices that execute program code, such as a network training application 112. The program code is stored on a non-transitory computer-readable medium. The network training application 112 can execute one or more processes to train and optimize a neural network for predicting risk indicators based on predictor variables 124 and maintaining a monotonic relationship between the common factors of the predictor variables 124 and the predicted risk indicators.

In some aspects, the network training application 112 can build and train a neural network 120 utilizing neural network training samples 126. The neural network training samples 126 can include multiple training vectors consisting of training predictor variables and training risk indicator outputs corresponding to the training vectors. The neural network training samples 126 can be stored in one or more network-attached storage units on which various repositories, databases, or other structures are stored. Examples of these data structures are the risk data repository 122.

Network-attached storage units may store a variety of different types of data organized in a variety of different ways and from a variety of different sources. For example, the network-attached storage unit may include storage other than primary storage located within the network training server 110 that is directly accessible by processors located therein. In some aspects, the network-attached storage unit may include secondary, tertiary, or auxiliary storage, such as large hard drives, servers, virtual memory, among other types. Storage devices may include portable or non-portable storage devices, optical storage devices, and various other mediums capable of storing and containing data. A machine-readable storage medium or computer-readable storage medium may include a non-transitory medium in which data can be stored and that does not include carrier waves or transitory electronic signals. Examples of a non-transitory medium may include, for example, a magnetic disk or tape, optical storage media such as a compact disk or digital versatile disk, flash memory, memory, or memory devices.

The risk assessment server 118 can include one or more processing devices that execute program code, such as a risk assessment application 114. The program code is stored on a non-transitory computer-readable medium. The risk assessment application 114 can execute one or more processes to utilize the neural network 120 trained by the network training application 112 to predict risk indicators based on input predictor variables 124. In addition, the neural network 120 can also be utilized to generate explanation codes for the predictor variables, which indicate an effect or an amount of impact that one or more predictor variables have on the risk indicator.

The output of the trained neural network 120 can be utilized to modify a data structure in the memory or a data storage device. For example, the predicted risk indicator and/or the explanation codes can be utilized to reorganize, flag, or otherwise change the predictor variables 124 involved in the prediction by the neural network 120. For instance, predictor variables 124 stored in the risk data repository 122 can be attached with flags indicating their respective amount of impact on the risk indicator. Different flags can be utilized for different predictor variables 124 to indicate different levels of impacts. Additionally, or alternatively, the locations of the predictor variables 124 in the storage, such as the risk data repository 122, can be changed so that the predictor variables 124 or groups of predictor variables 124 are ordered, ascendingly or descendingly, according to their respective amounts of impact on the risk indicator.

By modifying the predictor variables 124 in this way, a more coherent data structure can be established which enables the data to be searched more easily. In addition, further analysis of the neural network 120 and the outputs of the neural network 120 can be performed more efficiently. For instance, predictor variables 124 having the most impact on the risk indicator can be retrieved and identified more quickly based on the flags and/or their locations in the risk data repository 122. Further, updating the neural network, such as re-training the neural network based on new values of the predictor variables 124, can be performed more efficiently especially when computing resources are limited. For example, updating or retraining the neural network can be performed by incorporating new values of the predictor variables 124 having the most impact on the output risk indicator based on the attached flags without utilizing new values of all the predictor variables 124.

Furthermore, the risk assessment computing system 130 can communicate with various other computing systems, such as client computing systems 104. For example, client computing systems 104 may send risk assessment queries to the risk assessment server 118 for risk assessment, or may send signals to the risk assessment server 118 that control or otherwise influence different aspects of the risk assessment computing system 130. The client computing systems 104 may also interact with user computing systems 106 via one or more public data networks 108 to facilitate interactions between users of the user computing systems 106 and interactive computing environments provided by the client computing systems 104.

Each client computing system 104 may include one or more third-party devices, such as individual servers or groups of servers operating in a distributed manner. A client computing system 104 can include any computing device or group of computing devices operated by a seller, lender, or other providers of products or services. The client computing system 104 can include one or more server devices. The one or more server devices can include or can otherwise access one or more non-transitory computer-readable media. The client computing system 104 can also execute instructions that provide an interactive computing environment accessible to user computing systems 106. Examples of the interactive computing environment include a mobile application specific to a particular client computing system 104, a web-based application accessible via a mobile device, etc. The executable instructions are stored in one or more non-transitory computer-readable media.

The client computing system 104 can further include one or more processing devices that are capable of providing the interactive computing environment to perform operations described herein. The interactive computing environment can include executable instructions stored in one or more non-transitory computer-readable media. The instructions providing the interactive computing environment can configure one or more processing devices to perform operations described herein. In some aspects, the executable instructions for the interactive computing environment can include instructions that provide one or more graphical interfaces. The graphical interfaces are used by a user computing system 106 to access various functions of the interactive computing environment. For instance, the interactive computing environment may transmit data to and receive data from a user computing system 106 to shift between different states of the interactive computing environment, where the different states allow one or more electronics transactions between the user computing system 106 and the client computing system 104 to be performed.

In some examples, a client computing system 104 may have other computing resources associated therewith (not shown in FIG. 1), such as server computers hosting and managing virtual machine instances for providing cloud computing services, server computers hosting and managing online storage resources for users, server computers for providing database services, and others. The interaction between the user computing system 106 and the client computing system 104 may be performed through graphical user interfaces presented by the client computing system 104 to the user computing system 106, or through an application programming interface (API) calls or web service calls.

A user computing system 106 can include any computing device or other communication device operated by a user, such as a consumer or a customer. The user computing system 106 can include one or more computing devices, such as laptops, smartphones, and other personal computing devices. A user computing system 106 can include executable instructions stored in one or more non-transitory computer-readable media. The user computing system 106 can also include one or more processing devices that are capable of executing program code to perform operations described herein. In various examples, the user computing system 106 can allow a user to access certain online services from a client computing system 104 or other computing resources, to engage in mobile commerce with a client computing system 104, to obtain controlled access to electronic content hosted by the client computing system 104, etc.

For instance, the user can use the user computing system 106 to engage in an electronic transaction with a client computing system 104 via an interactive computing environment. An electronic transaction between the user computing system 106 and the client computing system 104 can include, for example, the user computing system 106 being used to request online storage resources managed by the client computing system 104, acquire cloud computing resources (e.g., virtual machine instances), and so on. An electronic transaction between the user computing system 106 and the client computing system 104 can also include, for example, query a set of sensitive or other controlled data, access online financial services provided via the interactive computing environment, submit an online credit card application or other digital application to the client computing system 104 via the interactive computing environment, operating an electronic tool within an interactive computing environment hosted by the client computing system (e.g., a content-modification feature, an application-processing feature, etc.).

In some aspects, an interactive computing environment implemented through a client computing system 104 can be used to provide access to various online functions. As a simplified example, a website or other interactive computing environment provided by an online resource provider can include electronic functions for requesting computing resources, online storage resources, network resources, database resources, or other types of resources. In another example, a website or other interactive computing environment provided by a financial institution can include electronic functions for obtaining one or more financial services, such as loan application and management tools, credit card application and transaction management workflows, electronic fund transfers, etc. A user computing system 106 can be used to request access to the interactive computing environment provided by the client computing system 104, which can selectively grant or deny access to various electronic functions. Based on the request, the client computing system 104 can collect data associated with the user and communicate with the risk assessment server 118 for risk assessment. Based on the risk indicator predicted by the risk assessment server 118, the client computing system 104 can determine whether to grant the access request of the user computing system 106 to certain features of the interactive computing environment.

In a simplified example, the system depicted in FIG. 1 can configure a neural network to be used both for accurately determining risk indicators, such as credit scores, using predictor variables and determining adverse action codes or other explanation codes for the predictor variables. A predictor variable can be any variable predictive of risk that is associated with an entity. Any suitable predictor variable that is authorized for use by an appropriate legal or regulatory framework may be used.

Examples of predictor variables used for predicting the risk associated with an entity accessing online resources include, but are not limited to, variables indicating the demographic characteristics of the entity (e.g., name of the entity, the network or physical address of the company, the identification of the company, the revenue of the company), variables indicative of prior actions or transactions involving the entity (e.g., past requests of online resources submitted by the entity, the amount of online resource currently held by the entity, and so on.), variables indicative of one or more behavioral traits of an entity (e.g., the timeliness of the entity releasing the online resources), etc. Similarly, examples of predictor variables used for predicting the risk associated with an entity accessing services provided by a financial institute include, but are not limited to, indicative of one or more demographic characteristics of an entity (e.g., age, gender, income, etc.), variables indicative of prior actions or transactions involving the entity (e.g., information that can be obtained from credit files or records, financial records, consumer records, or other data about the activities or characteristics of the entity), variables indicative of one or more behavioral traits of an entity, etc.

The predicted risk indicator can be utilized by the service provider to determine the risk associated with the entity accessing a service provided by the service provider, thereby granting or denying access by the entity to an interactive computing environment implementing the service. For example, if the service provider determines that the predicted risk indicator is lower than a threshold risk indicator value, then the client computing system 104 associated with the service provider can generate or otherwise provide access permission to the user computing system 106 that requested the access. The access permission can include, for example, cryptographic keys used to generate valid access credentials or decryption keys used to decrypt access credentials. The client computing system 104 associated with the service provider can also allocate resources to the user and provide a dedicated web address for the allocated resources to the user computing system 106, for example, by adding it in the access permission. With the obtained access credentials and/or the dedicated web address, the user computing system 106 can establish a secure network connection to the computing environment hosted by the client computing system 104 and access the resources via invoking API calls, web service calls, HTTP requests, or other proper mechanisms.

Each communication within the operating environment 100 may occur over one or more data networks, such as a public data network 108, a network 116 such as a private data network, or some combination thereof. A data network may include one or more of a variety of different types of networks, including a wireless network, a wired network, or a combination of a wired and wireless network. Examples of suitable networks include the Internet, a personal area network, a local area network (“LAN”), a wide area network (“WAN”), or a wireless local area network (“WLAN”). A wireless network may include a wireless interface or a combination of wireless interfaces. A wired network may include a wired interface. The wired or wireless networks may be implemented using routers, access points, bridges, gateways, or the like, to connect devices in the data network.

The number of devices depicted in FIG. 1 is provided for illustrative purposes. Different numbers of devices may be used. For example, while certain devices or systems are shown as single devices in FIG. 1, multiple devices may instead be used to implement these devices or systems. Similarly, devices or systems that are shown as separate, such as the network training server 110 and the risk assessment server 118, may be instead implemented in a signal device or system.

### Examples of Operations Involving Machine-Learning

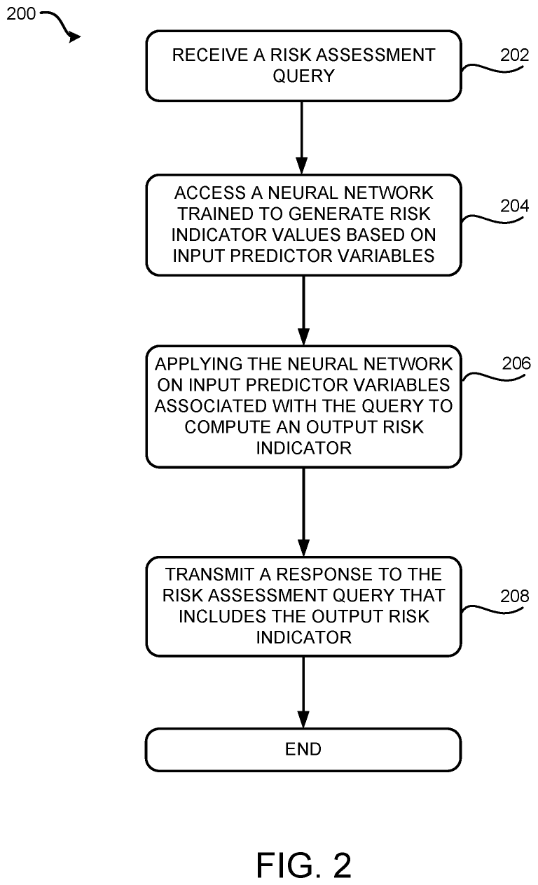

FIG. 2 is a flow chart depicting an example of a process 200 for utilizing a factor-level monotonic neural network to generate risk indicators for a target entity based on predictor variables associated with the target entity. One or more computing devices (e.g., the risk assessment server 118) implement operations depicted in FIG. 2 by executing suitable program code (e.g., the risk assessment application 114). For illustrative purposes, the process 200 is described with reference to certain examples depicted in the figures. Other implementations, however, are possible.

At block 202, the process 200 involves receiving a risk assessment query for a target entity from a remote computing device, such as a computing device associated with the target entity requesting the risk assessment. The risk assessment query can also be received by the risk assessment server 118 from a remote computing device associated with an entity authorized to request risk assessment of the target entity.

At operation 204, the process 200 involves accessing a neural network trained to generate risk indicator values based on input predictor variables or other data suitable for assessing risks associated with an entity. Examples of predictor variables can include data associated with an entity that describes prior actions or transactions involving the entity (e.g., information that can be obtained from credit files or records, financial records, consumer records, or other data about the activities or characteristics of the entity), behavioral traits of the entity, demographic traits of the entity, or any other traits that may be used to predict risks associated with the entity. In some aspects, predictor variables can be obtained from credit files, financial records, consumer records, etc. The risk indicator can indicate a level of risk associated with the entity, such as a credit score of the entity.

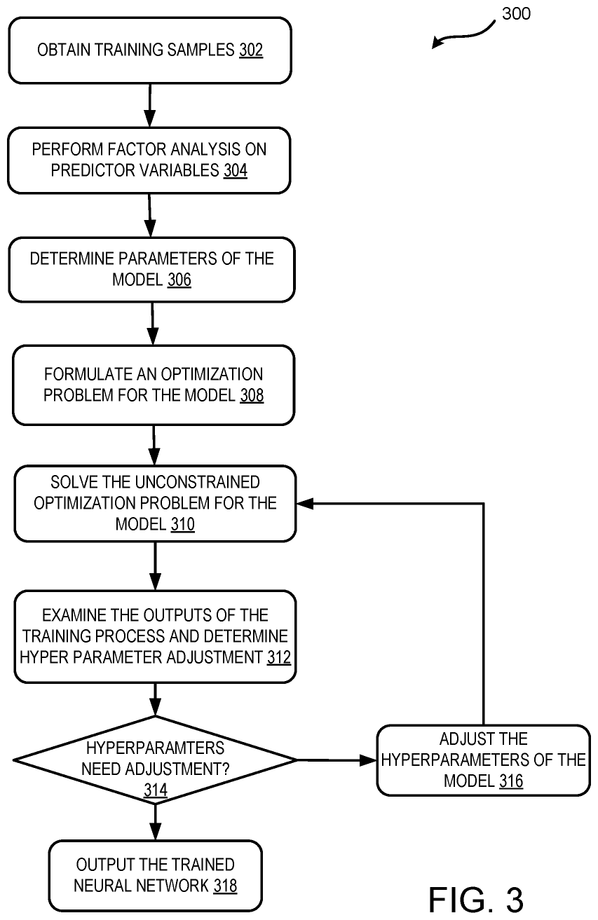

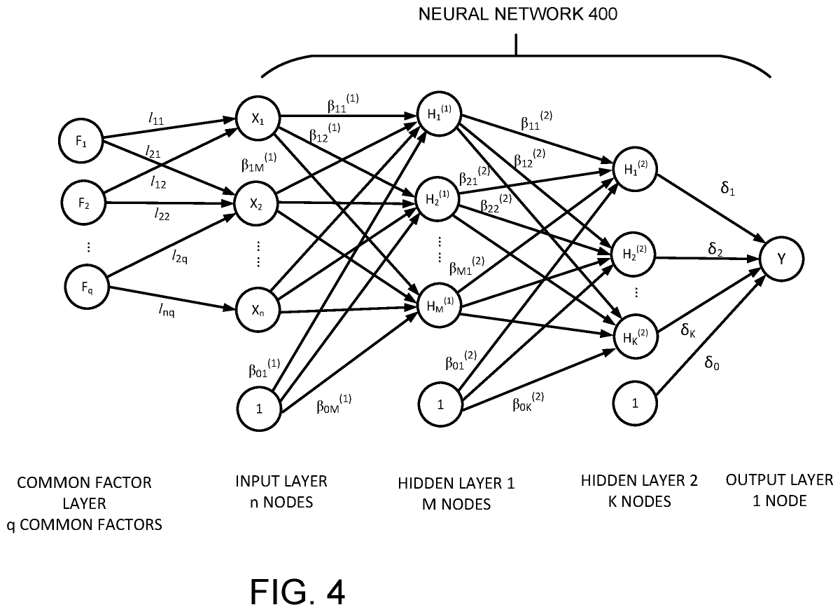

The neural network can be constructed and trained based on training samples including training predictor variables and training risk indicator outputs. Constraints can be imposed on the training of the neural network so that the neural network maintains a monotonic relationship between common factors of the input predictor variables and the risk indicator outputs. Additional details regarding training the neural network will be presented below with regard to FIGS. 3 and 4.

At operation 206, the process 200 involves applying the neural network to generate a risk indicator for the target entity specified in the risk assessment query. Predictor variables associated with the target entity can be used as inputs to the neural network. The predictor variables associated with the target entity can be obtained from a predictor variable database configured to store predictor variables associated with various entities. The output of the neural network would include the risk indicator for the target entity based on its current predictor variables.

At operation 208, the process 200 involves generating and transmitting a response to the risk assessment query. The response can include the risk indicator generated using the neural network. The risk indicator can be used for one or more operations that involve performing an operation with respect to the target entity based on a predicted risk associated with the target entity. In one example, the risk indicator can be utilized to control access to one or more interactive computing environments by the target entity. As discussed above with regard to FIG. 1, the risk assessment computing system 130 can communicate with client computing systems 104, which may send risk assessment queries to the risk assessment server 118 to request risk assessment. The client computing systems 104 may be associated with technological providers, such as cloud computing providers, online storage providers, or financial institutions such as banks, credit unions, credit-card companies, insurance companies, or other types of organizations. The client computing systems 104 may be implemented to provide interactive computing environments for customers to access various services offered by these service providers. Customers can utilize user computing systems 106 to access the interactive computing environments thereby accessing the services provided by these providers.

For example, a customer can submit a request to access the interactive computing environment using a user computing system 106. Based on the request, the client computing system 104 can generate and submit a risk assessment query for the customer to the risk assessment server 118. The risk assessment query can include, for example, an identity of the customer and other information associated with the customer that can be utilized to generate predictor variables. The risk assessment server 118 can perform a risk assessment based on predictor variables generated for the customer and return the predicted risk indicator to the client computing system 104.

Based on the received risk indicator, the client computing system 104 can determine whether to grant the customer access to the interactive computing environment. If the client computing system 104 determines that the level of risk associated with the customer accessing the interactive computing environment and the associated technical or financial service is too high, the client computing system 104 can deny access by the customer to the interactive computing environment. Conversely, if the client computing system 104 determines that the level of risk associated with the customer is acceptable, the client computing system 104 can grant access to the interactive computing environment by the customer and the customer would be able to utilize the various services provided by the service providers. For example, with the granted access, the customer can utilize the user computing system 106 to access clouding computing resources, online storage resources, web pages or other user interfaces provided by the client computing system 104 to execute applications, store data, query data, submit an online digital application, operate electronic tools, or perform various other operations within the interactive computing environment hosted by the client computing system 104.

In other examples, the neural network can also be utilized to generate adverse action codes or other explanation codes for the predictor variables. Adverse action code can indicate an effect or an amount of impact that a predictor variable has or a group of predictor variables have on the value of the risk indicator, such as credit score (e.g., the relative negative impact of the predictor variable(s) on a risk indicator such as the credit score). In some aspects, the risk assessment application uses the neural network to provide adverse action codes that are compliant with regulations, business policies, or other criteria used to generate risk evaluations. Examples of regulations to which the neural network conforms and other legal requirements include the Equal Credit Opportunity Act (“ECOA”), Regulation B, and reporting requirements associated with ECOA, the Fair Credit Reporting Act (“FCRA”), the Dodd-Frank Act, and the Office of the Comptroller of the Currency (“OCC”).

In some implementations, the explanation codes can be generated for a subset of the predictor variables that have the highest impact on the risk indicator. For example, the risk assessment application 114 can determine the rank of each predictor variable based on the impact of the predictor variable on the risk indicator. A subset of the predictor variables including a certain number of highest-ranked predictor variables can be selected and explanation codes can be generated for the selected predictor variables. The risk assessment application 114 may provide recommendations to a target entity based on the generated explanation codes. The recommendations may indicate one or more actions that the target entity can take to improve the risk indicator (e.g., improve a credit score).

Referring now to FIG. 3, a flow chart depicting an example of a process 300 for building and training a factor-level monotonic neural network is presented. FIG. 3 will be presented in conjunction with FIG. 4 where a diagram depicting an example of a multi-layer neural network 400 is presented. One or more computing devices (e.g., the network training server 110) implement operations depicted in FIG. 3 by executing suitable program code (e.g., the network training application 112). For illustrative purposes, the process 300 is described with reference to certain examples depicted in the figures. Other implementations, however, are possible.

At block 302, the process 300 involves the network training server 110 obtaining training samples for the neural network model. The training samples can include multiple training vectors consisting of training predictor variables X and known outputs Y (i.e. training risk indicators). The t-th training vector can include an n-dimensional input predictor vector \vec{X}^{(t)}=[X₁^{(t)}, . . . , Xₙ^{(t)}] constituting particular values of the training predictor variables, where t=1, . . . , T and T is the number of training vectors in the training samples. The t-th training vector can also include a training output Y^{(t)}, i.e., a training risk indicator or outcome corresponding to the input predictor vector X^{(t)}.

The training samples can be generated based on a dataset containing various variables associated with different entities or individuals and the associated risk indicators. In some examples, the training samples are generated to only include predictor variables X that are appropriate and allowable for predicting Y. These appropriate and allowable predictor variables can be selected based on regulatory requirements, business requirements, contractual requirements, or any combination thereof. In some scenarios, values of some predictor variables may be missing in the dataset. These missing values can be handled by substituting these values with values that logically are acceptable, filling these values with values received from a user interface, or both. In other examples, the data records with missing values are removed from the training samples.

At block 304, the process 300 involves the network training server 110 performing factor analysis on the predictor variables \vec{X}^{(t)}, t=1, . . . , T. In some aspects, the factor analysis involves determining common factors from the predictor variables. Each common factor can be a single variable indicating a relationship among a subset of the predictor variables. For instance, in a neural network using input predictor variables X₁ through Xₙ, factor analysis can be performed on the set of predictor variables X₁ through Xₙ to identify common factors F₁ through F_{q}. For example, two related predictor variables X₁ and X₂ from the set of predictor variables may share the common factor F₁, and two other related predictor variables X₃ and X₄ from the set of predictor variables may share the common factor F₂.

In additional aspects, the factor analysis involves determining specific factors from the predictor variables. A specific factor contains unique information associated with a predictor variable, where the unique information is specific to that predictor variable and is not captured by common factors corresponding to the predictor variable. Continuing with the example above, a factor analysis of the predictor variables X₁ through Xₙ can identify specific factors ε₁ through εₙ. The specific factor ε₁ is associated with the predictor variable X₁, the specific factor ε₂ is associated with the predictor variable X₂, and so on.

In some aspects, the factor analysis leads to the following equation:

$${Z}_{i} = \frac{{X}_{i} - {μ}_{i}}{{σ}_{i}} = {\sum }_{j = 1}^{q} {ℓ}_{ij} {F}_{j} + {ε}_{i} . \qquad ( 1 )$$

Here, μᵢ and σᵢ are the mean and the standard deviation of a dataset of the predictor variable Xᵢ, respectively, and i=1, . . . , n. The equation relates the predictor variable Xᵢ to a weighted sum of q common factors Fⱼ. The weight of each common factor Fⱼ is the respective coefficient [symbol] ᵢⱼ for the i^{th} predictor variable Xᵢ. If, for the predictor variable Xᵢ and common factor Fⱼ, [symbol] ᵢⱼ is non-zero, the predictor variable Xᵢ can be referred to as loading on the common factor Fⱼ. As such, the coefficients [symbol] ᵢⱼ are also referred herein to as loading coefficients.

In general, q is much smaller than n. For example, for n=100 predictor variables, the factor analysis can generate q=10 different common factors. As such, multiple predictor variables can load on one common factor. The common factors represent the underlying latent variables influencing the predictor variables. For example, a common factor can include the credit card utilization of a consumer. Different predictor variables can load on the credit card utilization common factor, such as the credit card utilization on retail cards of the consumer in the past three months, the credit card utilization on revolving cards in the past 24 months, the number of credit cards with more than 50% utilization, etc. By requiring a monotonic relationship between each common factor and the neural network model output (i.e. the risk indicator), the individual predictor variable does not need to maintain a monotonic relationship with the risk indicator. Without this input-level monotonicity constraint, the predictability of the neural network model can be improved. In the meanwhile, as will be discussed below in detail, the interpretability requirements of the neural network model can be satisfied using the common factors.

In some examples, the factor analysis is performed such that a predictor variable loads on a smaller number of common factors. In this way, the neural network is more interpretable. For example, if each predictor variable loads on only one common factor, the impact of a given predictor variable is limited to only the common factor it loads on. The relationship between the predictor variable and the risk indicator can be interpreted through this one common factor. In some implementations, rotation methods can be utilized in the factor analysis to obtain common factors such that a predictor variable loads on a small number of the common factors. Exploratory factor analysis and confirmatory factor analysis can also be utilized to obtain common factors and specific factors for the predictor variables as shown in Eqn. (3). An example method of the factor analysis that can be utilized here is described below. Although block 304 involves the network training server 110 performing the factor analysis on the predictor variables, in other examples, the factor analysis can be performed by another system. The network training server 110 can receive or otherwise access the loading coefficients [symbol] ᵢⱼ of the predictor variables generated by that system.

At block 306, the process 300 involves the network training server 110 determining the parameters of the neural network model and formulating an optimization problem for the neural network model. The parameters of the neural network model include architectural parameters of the neural network model. Examples of architectural parameters of the neural network can include the number of layers in the neural network, the number of nodes in each layer, the activation functions for each node, or some combination thereof. For instance, the dimension of the input variables can be utilized to determine the number of nodes in the input layer. For an input predictor vector having n input variables, the input layer of the neural network can be constructed to have n nodes, corresponding to the n input variables, and a constant node. Likewise, the number of outputs in a training sample can be utilized to determine the number of nodes in the output layer, that is, one node in the output layer corresponds to one output. Other aspects of the neural network, such as the number of hidden layers, the number of nodes in each hidden layer, and the activation function at each node can be determined based on various factors such as the complexity of the prediction problem, available computation resources, accuracy requirement, and so on. In some examples, some of the architectural parameters, such as the number of nodes in each hidden layer can be randomly selected.

FIG. 4 illustrates a diagram depicting an example of a multi-layer neural network 400. A neural network model is a memory structure comprising nodes connected via one or more layers. In this example, the neural network 400 includes an input layer having a bias node and n nodes each corresponding to a training predictor variable in the (n+1)-dimension input predictor vector \vec{X}=[1, X₁, . . . , Xₙ]. The neural network 400 further includes a first hidden layer having M nodes and a bias node, a second hidden layer having K nodes and a bias node, and an output layer for a single output Y, i.e. the risk indicator or outcome. The weights of the connections from the input layer to the first hidden layer can be denoted as βᵢⱼ⁽¹⁾, where i=0, . . . , n and j=1, . . . , M, β₀ⱼ⁽ⁱ⁾ are bias weights and others are non-bias weights. Similarly, the weights of the connections from the first hidden layer to the second hidden layer can be denoted as βⱼₖ⁽²⁾, where j=0, . . . , M and k=1, . . . , K, β₀ₖ⁽²⁾ are bias weights and others are non-bias weights. The weights of the connections from the second hidden layer to the output layer can be denoted as δₖ, where k=1, . . . , K.

The weights of the connections between layers can be utilized to determine the inputs to a current layer based on the output of the previous layer. For example, the input to the j^{th} node in the first hidden layer can be determined as Σᵢ₌₀ⁿβᵢⱼ⁽¹⁾(Xᵢ−μᵢ)/σᵢ=Σᵢ₌₀ⁿβᵢⱼ⁽¹⁾Zᵢ, where Xᵢ, i=0, . . . n, are the predictor variables in the bias and input predictor vector \vec{X}, and j=1, . . . , M. Similarly, the input to the k^{th} node in the second hidden layer can be determined as Σⱼ₌₀^{M}βⱼₖ⁽²⁾Hⱼ⁽¹⁾, where Hⱼ⁽¹⁾, j=0, . . . M, are the bias and outputs of the nodes in the first hidden layer and k=1, . . . , K. The input to the output layer of the neural network can be determined as Σₖ₌₀^{K}δₖHₖ⁽²⁾, where Hₖ⁽²⁾ are the bias and the output of the k^{th} node at the second hidden layer.

The output of a hidden layer node or an output layer node can be determined by an activation function implemented at that particular node. In some aspects, the output of each of the hidden nodes can be modeled as a logistic function of the input to that hidden node and the output Y can be modeled as a logistic function of the outputs of the nodes in the last hidden layer. Specifically, the neural network nodes in the neural network 400 presented in FIG. 4 can employ the following activation functions:

$${H}_{j}^{( 1 )} = \frac{1}{1 + exp ( - Z {β}_{\cdot j}^{( 1 )} )} = φ ( Z {β}_{\cdot j}^{( 1 )} ) , {Z}_{i} = \frac{{X}_{i} - {μ}_{i}}{{σ}_{i}} = {L}_{i} . F + {ε}_{i} , \\ where X = [ 1 , {X}_{1} , … , {X}_{n} ] , {β}_{\cdot j}^{( 1 )} = {[ {β}_{0 j}^{( 1 )} , {β}_{1 j}^{( 1 )} , … , {β}_{nj}^{( 1 )} ]}^{T} ; \qquad ( 2 )$$

$${H}_{k}^{( 2 )} = \frac{1}{1 + exp ( - {H}^{( 1 )} {β}_{\cdot k}^{( 2 )} )} = φ ( {H}^{( 1 )} {β}_{\cdot k}^{( 2 )} ) , \\ where {H}^{( 1 )} = [ 1 , {H}_{1}^{( 1 )} , … , {H}_{M}^{( 1 )} ] , \\ {β}_{\cdot k}^{( 2 )} = {[ {β}_{0 k}^{( 2 )} , {β}_{1 k}^{( 2 )} , … , {β}_{Mk}^{( 2 )} ]}^{T} ; and \qquad ( 3 )$$

$$Y = \frac{1}{1 + exp ( - {H}^{( 2 )} δ )} = φ ( {H}^{( 2 )} δ ) , \\ where {H}^{( 2 )} = [ 1 , {H}_{1}^{( 2 )} , … , {H}_{K}^{( 2 )} ] , δ = {[ {δ}_{0} , {δ}_{1} , {δ}_{2} , … , {δ}_{K} ]}^{T} . \qquad ( 4 )$$

In some examples, the predictor variables Xᵢ are normalized as

$${Z}_{i} = \frac{{X}_{i} - {μ}_{i}}{{σ}_{i}}$$

as shown in equation (1), and the above relationships can be represented as

$$Y = φ ( {H}^{( 2 )} δ ) , {H}_{k}^{( 2 )} = φ ( {H}^{( 1 )} {β}_{\cdot k}^{( 2 )} ) , \\ {H}_{j}^{( 1 )} = φ ( Z {β}_{\cdot j}^{( 1 )} ) , {Z}_{i} = \frac{{X}_{i} - {μ}_{i}}{{σ}_{i}} = {L}_{i} . F + {ε}_{i} = {\sum }_{j = 1}^{q} {ℓ}_{ij} {F}_{j} + {ε}_{i} . \qquad ( 5 )$$

For illustrative purposes, the neural network 400 illustrated in FIG. 4 and described above includes two hidden layers and a single output. But neural networks with any number of hidden layers and any number of outputs can be formulated in a similar way, and the following analysis can be performed accordingly. Further, in addition to the logistic function presented above, the neural network 400 can have any differentiable sigmoid activation function that accepts real number inputs and outputs a real number. Examples of activation functions include, but are not limited to, the logistic, arc-tangent, and hyperbolic tangent functions. In addition, different layers of the neural network can employ the same or different activation functions.

FIG. 4 also illustrates a common factor layer containing nodes representing common factors of the predictor variables X₁, . . . , Xᵢ, for the input layer of the neural network 400. The common factor layer is not part of the neural network 400 and is shown for illustration purposes only. In the example shown in FIG. 4, the common factor layer shows the q common factors of the n input predictor variables. Each node in the common factor layer represents a common factor Fₚ of the predictor variables. The connections between the common factors and the nodes in the input layer have weights represented by the corresponding loading coefficients lᵢⱼ.

Referring back to FIG. 3, at block 308, the process 300 involves the network training server 110 constructing an optimization problem for the neural network model. Training a neural network can include solving an optimization problem to find the parameters of the neural network, such as the weights of the connections in the neural network. In particular, training the neural network 400 can involve determining the values of the weights β and δ in the neural network 400, i.e. β⁽¹⁾, β⁽²⁾, and δ, so that a loss function L(w) of the neural network 400 is minimized, where w is a generic weight and can represent all the weights in the neural network, such as β⁽¹⁾, β⁽²⁾, and δ in the neural network 400 shown in FIG. 4. The loss function L(w) can be defined as, or as a function of, the difference between the outputs predicted using the neural network with weights w, denoted as Ŷ=[Ŷ⁽¹⁾ Y⁽²⁾ . . . Ŷ^{(T)}], and the observed output Y=[Y⁽¹⁾ Y⁽²⁾ . . . Y^{(T)}]. In some aspects, the loss function L(w) can be defined as the negative log-likelihood of the neural network distortion between the predicted value of the output Ŷ and the observed output values Y.

However, the neural network trained in this way does not guarantee the monotonic relationship between the common factors of the input predictor vectors and their corresponding outputs. A factor-level monotonic neural network maintains a monotonic relationship between the values of each common factor of the predictor variables in the training vectors, i.e. {Xᵢ⁽¹⁾, Xᵢ⁽²⁾, . . . , Xᵢ^{(T)}} and the training output {Y⁽¹⁾, Y⁽²⁾, . . . , Y^{(T)}}, where i=1, . . . , n. A monotonic relationship between a common factor Fₚ of the predictor variables and the output Y exists if an increase in the value of the common factor Fₚ would always lead to a non-positive (or a non-negative) change in the value of Y. In other words, if Fₚ⁽ⁱ⁾>Fₚ^{(j)}, then Y⁽ⁱ⁾≥Y^{(j)} for any i and j, or Y⁽ⁱ⁾≤Y^{(j)} for any i and j, where i,j=1, . . . , T.

To assess the impact of a common factor Fₚ on the output Y, the following partial derivative can be examined:

$$\begin{matrix}\frac{\partial Y}{\partial {F}_{p}} = {\sum }_{k} \frac{\partial Y}{\partial {H}_{k}^{( 2 )}} \frac{\partial {H}_{k}^{( 2 )}}{\partial {F}_{p}} \\ = {\sum }_{k} \frac{\partial Y}{\partial {H}_{k}^{( 2 )}} {\sum }_{j} \frac{\partial {H}_{k}^{( 2 )}}{\partial {H}_{j}^{( 1 )}} \frac{\partial {H}_{j}^{( 1 )}}{\partial {F}_{p}} \\ = {\sum }_{k} \frac{\partial Y}{\partial {H}_{k}^{( 2 )}} {\sum }_{j} \frac{\partial {H}_{k}^{( 2 )}}{\partial {H}_{j}^{( 1 )}} {\sum }_{i} \frac{\partial {H}_{j}^{( 1 )}}{\partial {Z}_{i}} \frac{\partial {Z}_{i}}{\partial {F}_{p}} \\ = {\sum }_{k} {\sum }_{j} {\sum }_{i} \frac{\partial Y}{\partial {H}_{k}^{( 2 )}} \frac{\partial {H}_{k}^{( 2 )}}{\partial {H}_{j}^{( 1 )}} \frac{\partial {H}_{j}^{( 1 )}}{\partial {Z}_{i}} \frac{\partial {Z}_{i}}{\partial {F}_{p}} \\ = {\sum }_{k} {\sum }_{j} {\sum }_{i} {δ}_{k} {β}_{jk}^{( 2 )} {β}_{ij}^{( 1 )} {ℓ}_{ip} {φ}^{′} ( {H}^{( 1 )} {β}_{\cdot k}^{( 2 )} ) {φ}^{′} ( Z {β}_{\cdot j}^{( 1 )} ) \\ = {\sum }_{k} {\sum }_{j} {φ}^{′} ( {H}^{( 1 )} {β}_{\cdot k}^{( 2 )} ) {φ}^{′} ( Z {β}_{\cdot j}^{( 1 )} ) ( {\sum }_{j} {ℓ}_{ip} {β}_{ij}^{( 1 )} {β}_{jk}^{( 2 )} {δ}_{k} )\end{matrix} \qquad ( 6 )$$

Since φ′(·)>0 (thus φ′ (H⁽¹⁾βₖ⁽²⁾)φ′(Zβⱼ⁽¹⁾)>0), a sufficient condition to ensure positive monotonicity between the common factor Fₚ and the output Y is:

$${\sum }_{i} {ℓ}_{ip} {β}_{ij}^{( 1 )} {β}_{jk}^{( 2 )} {δ}_{k} \geq 0 , ∀ j , k . \qquad ( 7 )$$

A similar condition holds for negative monotonicity. The sufficient condition given by equation (7) shows that, although individual predictor variables in the model may not have strictly monotonic trends, the common factor has a strictly monotonic trend that is controlled by the aggregate effect of all the predictor variables that load on a common factor in the neural network. Compared with the input-level monotonicity where monotonicity exists between each input predictor variable and the output, this factor-level monotonicity is a more relaxed constraint and the trends of individual predictor variables can be non-monotonic as long as the common factor is monotonic with respect to the output.

The term Σᵢ [symbol] ᵢₚβᵢⱼ⁽¹⁾βⱼₖ⁽²⁾δₖ represents a “path” from a common factor to the output of the neural network. For each common factor Fₚ, this path provides how the neural gets from the common factor to the output through nodes Hⱼ⁽¹⁾ and Hₖ⁽²⁾. In the example shown in FIG. 4, the path for the common factor Fₚ includes the node representing Fₚ in the common factor layer and all the nodes from the input layer to the output layer through which the output node can be reached from the common factor node.

For a set of values to be greater than or equal to 0, the minimum of the set of values must be greater than or equal to 0. As such, the above condition in equation (7) is equivalent to the following condition (referred to herein as a “path constraint”):

$${min}_{p , j , k} {\sum }_{i} {ℓ}_{ip} {β}_{ij}^{( 1 )} {β}_{jk}^{( 2 )} {δ}_{k} \geq 0 \qquad ( 8 )$$

Assuming without loss of generality that the relationship between Fₚ and Y is positive, and denoting the loss of the neural network as L(w), the optimization problem to minimize the neural network loss subject to the model being monotonic in every common factor can be formulated as

$$min L ( w ) \\ subject to : {min}_{p , j , k} {\sum }_{i} {ℓ}_{ip} {β}_{ij}^{( 1 )} {β}_{jk}^{( 2 )} {δ}_{k} \geq 0 \qquad ( 9 )$$

where min L(w) is the objective function of the optimization problem. w is the weight vector consisting of all the weights in the neural network, e.g. β⁽¹⁾, β⁽²⁾, and δ. L(w) is the loss function of the neural network as defined above, i=1, . . . , n, p=1, . . . , q, j=1, . . . , M, and k=1, . . . , K.

The constrained optimization problem in Equation (9), however, can be computationally expensive to solve, especially for large scale neural networks, i.e. neural networks involving a large number of the input variables, a large number of the nodes in the neural network, and/or a large number of training samples. In order to reduce the complexity of the optimization problem, a Lagrangian multiplier λ can be introduced to approximate the optimization problem in equation (9) using a Lagrangian expression by adding a penalty term in the loss function to represent the constraints, and to solve the optimization problem as a sequence of unconstrained optimization problems. In some aspects, the optimization problem in equation (9) can be formulated as minimizing a modified loss function of the neural network, \tilde{L}(w):

min \tilde{L}(w)=min L(w)+λLSE(w), (10)

where LSE(w) is a LogSumExp (“LSE”) function of the weight vector w and it smoothly approximates the path constraint in Equation (9) so that it is differentiable in order to find the optimal value of the objective function \tilde{L}(w). The term LSE(w) can represent either a penalty to the loss function, in case the constraint is not satisfied, or a reward to the loss function, in case the constraint is satisfied. The Lagrangian multiplier λ can adjust the relative importance between enforcing the constraint and minimizing the loss function L(w). A higher value of λ would indicate enforcing the constraints has higher weight and the value of L(w) might not be optimized properly. A lower value of λ would indicate that optimizing the loss function is more important and the constraints might not be satisfied.

In some aspects, the path constraint can be approximated and thus LSE(w) can be formulated as:

$${min}_{p , j , k} {\sum }_{i = 1 , … , n} {ℓ}_{ip} {β}_{ij}^{( 1 )} {β}_{jk}^{( 2 )} {δ}_{k} \approx - \frac{1}{C} log {\sum }_{p = 1}^{q} {\sum }_{j = 1}^{M} {\sum }_{k = 1}^{K} {e}^{- C {\sum }_{i = 1 , … , n} {ℓ}_{ip} {β}_{ij}^{( 1 )} {β}_{jk}^{( 2 )} {δ}_{k}} \qquad ( 11 )$$

$$LSE ( w ) = \frac{1}{C} log {\sum }_{p = 1}^{q} {\sum }_{j = 1}^{M} {\sum }_{k = 1}^{K} {e}^{- C {\sum }_{i = 1 , … , n} {ℓ}_{ip} {β}_{ij}^{( 1 )} {β}_{jk}^{( 2 )} {δ}_{k}} .$$

In equation (11), the parameter C is a scaling factor to ensure the approximation of the path constraint in equation (9) is accurate and robust, and

$$C = {10}^{round ( 1 - {log}_{10} \vert {min}_{p} {min}_{j} {min}_{k} {\sum }_{i = 1 , … , n} {ℓ}_{ip} {β}_{ij}^{( 1 )} {β}_{jk}^{( 2 )} {δ}_{k} \vert )} + 1 \qquad ( 12 )$$

Note that the LSE(w) term does not include the negative sign in the approximation of the path constraint. In this way, the loss \tilde{L}(w) can be rewarded (i.e., make it smaller) if the minimum of the path is non-negative and penalized (i.e., make it larger) if the minimum of the path is negative. For illustrative purposes, an LSE function is presented herein as a smooth differentiable expression of the path constraint. But other functions that can transform the path constraint into a smooth differential expression can be utilized to introduce the path constraint into the objective function of the optimization problem.

By enforcing the training of the neural network to satisfy the specific rules set forth in the monotonic constraint in Equation (9), a special neural network structure can be established that inherently carries the monotonic property. There is thus no need to perform additional adjustments to the neural network for monotonicity purposes. As a result, the training of the neural network can be completed with fewer operations and thus requires fewer computational resources.

In some aspects, one or more regularization terms can also be introduced into the modified loss function \tilde{L}(w) to regularize the optimization problem. In one example, a regularization term ∥w∥₂² i.e. the L-2 norm of the weight vector w, can be introduced. The regularization term ∥w∥₂² can prevent values of the weights on the paths in the neural network from growing too large so that the neural network can remain stable over time. In addition, introducing the regularization term ∥w∥₂² can prevent overfitting of the neural network, i.e. preventing the neural network from being trained to match the particular set of training samples too closely so that it fails to predict future outputs reliably.

In addition, ∥w∥₁, i.e. the L-1 norm of the weight vector w, can also be introduced as a regularization term to simplify the structure of the neural network. The regularization term ∥w∥₁ can be utilized to force weights with small values to be 0, thereby eliminating the corresponding connections in the neural network. By introducing these additional regularization terms, the optimization problem now becomes:

$${min}_{w} \tilde{L} ( w ) = {min}_{w} L ( w ) + λ ( {α}_{1} LSE ( w ) + {α}_{2} \frac{1}{2} {‖ w ‖}_{2}^{2} + ( 1 - {α}_{1} - {α}_{2} ) {‖ w ‖}_{1} ) \qquad ( 13 )$$

The parameters α₁ and α₂ can be utilized to adjust the relative importance of these additional regularization terms with regard to the path constraint. Additional terms can be introduced in the regularization terms to force the neural network model to have various other properties.

Utilizing additional rules, such as the regularization terms in Equation (13), further increases the efficiency and efficacy of the training of the neural network by integrating the various requirements into the training process. For example, by introducing the L-1 norm of the weight vector w into the modified loss function, the structure of the neural network can be simplified by using fewer connections in the neural network. As a result, the training of the neural network becomes faster, requires the consumption of fewer resources, or both. Likewise, rules represented by the L-2 norm of the weight vector w can ensure the trained neural network to be less likely to have an overfitting problem and also be more stable. This eliminates the need for additional adjustment of the trained neural network to address the overfitting and stability issues, thereby reducing the training time and resource consumption of the training process.

Referring back to FIG. 3, block 310 involves the network training server 110 solving the optimization problem formulated in equation (13). To solve the problem, the hyperparameter values can be initialized. The hyperparameters include, for example, the weight parameters w of the neural network, the hyperparameters λ, α₁, α₂, the architecture hyperparameters such as the number of nodes in each hidden layer M and K, and the number of iterations of the optimization process. Each of these hyperparameters can be initialized to a deterministic value or a random value. By fixing the values of the hyperparameters, the optimization problem in equation (13) can be solved using any first or second order unconstrained minimization algorithm to find the optimized weight factor w*. For example, numerical algorithms such as the limited-memory Broyden-Fletcher-Goldfarb-Shanno (L-BFGS) or the Orthant-wise limited-memory quasi-Newton (OWL-QN) algorithms can be utilized to solve the optimization problem. To utilize these algorithms, the gradient of the LSE penalty/reward LSE (w) can be derived as follows and feed into the algorithm to solve the optimization problem.

Define the LSE (w) penalty/reward as

$$P {=}^{def} LSE ( w ) = \frac{1}{C} log {\sum }_{p} {\sum }_{j} {\sum }_{k} {e}^{- C {\sum }_{i} {ℓ}_{ip} {β}_{ij}^{( 1 )} {β}_{jk}^{( 2 )} {δ}_{k}} . \qquad ( 14 )$$

Let S be defined as the argument of the logarithm of P in equation (14), that is

$$S {=}^{def} {\sum }_{p} {\sum }_{j} {\sum }_{k} {e}^{- C {\sum }_{i} {ℓ}_{ip} {β}_{ij}^{( 1 )} {β}_{jk}^{( 2 )} {δ}_{k}} . \qquad ( 15 )$$

The partial of P with respect to a generic weight w becomes

$$\frac{\partial P}{\partial w} = \frac{1}{C} \frac{1}{S} \frac{\partial S}{\partial w} = \frac{1}{C} \frac{1}{S} {\sum }_{p} {\sum }_{j} {\sum }_{k} {e}^{- C {\sum }_{i} {ℓ}_{ip} {β}_{ij}^{( 1 )} {β}_{jk}^{( 2 )} {δ}_{k}} ( - C ) {\sum }_{i} \frac{\partial }{\partial w} {ℓ}_{ip} {β}_{ij}^{( 1 )} {β}_{jk}^{( 2 )} {δ}_{k} = - \frac{1}{S} {\sum }_{p} {\sum }_{j} {\sum }_{k} {e}^{- C {\sum }_{i} {ℓ}_{ip} {β}_{ij}^{( 1 )} {β}_{jk}^{( 2 )} {δ}_{k}} {\sum }_{i} \frac{\partial }{\partial w} {ℓ}_{ip} {β}_{ij}^{( 1 )} {β}_{jk}^{( 2 )} {δ}_{k} . \qquad ( 16 )$$

Since the bias weights are not included in the penalty, each of these partial derivatives is 0. The differentiation for each of the non-intercept weights can be obtained by applying equation (16) and simplifying.
Case 1: w=βᵢⱼ⁽¹⁾. Equation (16) becomes

$$\frac{\partial P}{\partial {β}_{ij}^{( 1 )}} = - \frac{1}{S} {\sum }_{p} {\sum }_{j} {\sum }_{k} {e}^{- C {\sum }_{i} {ℓ}_{ip} {β}_{ij}^{( 1 )} {β}_{jk}^{( 2 )} {δ}_{k}} {\sum }_{i} \frac{\partial }{\partial w} {ℓ}_{ip} {β}_{ij}^{( 1 )} {β}_{jk}^{( 2 )} {δ}_{k} = - \frac{1}{S} {\sum }_{p} {\sum }_{k} {e}^{- C {\sum }_{i} {ℓ}_{ip} {β}_{ij}^{( 1 )} {β}_{jk}^{( 2 )} {δ}_{k}} ( {ℓ}_{ip} {β}_{jk}^{( 2 )} {δ}_{k} ) . \qquad ( 17 )$$

Case 2: w=βⱼₖ⁽²⁾. Equation (16) becomes

$$\frac{\partial P}{\partial {β}_{jk}^{( 2 )}} = - \frac{1}{S} {\sum }_{p} {\sum }_{j} {\sum }_{k} {e}^{- C {\sum }_{i} {ℓ}_{ip} {β}_{ij}^{( 1 )} {β}_{jk}^{( 2 )} {δ}_{k}} {\sum }_{i} \frac{\partial }{\partial w} {ℓ}_{ip} {β}_{ij}^{( 1 )} {β}_{jk}^{( 2 )} {δ}_{k} = - \frac{1}{S} {\sum }_{p} {\sum }_{i} {e}^{- C {\sum }_{i} {ℓ}_{ip} {β}_{ij}^{( 1 )} {β}_{jk}^{( 2 )} {δ}_{k}} ( {ℓ}_{ip} {β}_{ij}^{( 1 )} {δ}_{k} ) . \qquad ( 18 )$$

Case 3: w=δₖ. Equation (16) gives

$$\frac{\partial P}{\partial {δ}_{k}} = - \frac{1}{S} {\sum }_{p} {\sum }_{j} {\sum }_{k} {e}^{- C {\sum }_{i} {ℓ}_{ip} {β}_{ij}^{( 1 )} {β}_{jk}^{( 2 )} {δ}_{k}} {\sum }_{i} \frac{\partial }{\partial w} {ℓ}_{ip} {β}_{ij}^{( 1 )} {β}_{jk}^{( 2 )} {δ}_{k} = - \frac{1}{S} {\sum }_{p} {\sum }_{i} {e}^{- C {\sum }_{i} {ℓ}_{ip} {β}_{ij}^{( 1 )} {β}_{jk}^{( 2 )} {δ}_{k}} ( {ℓ}_{ip} {β}_{ij}^{( 1 )} {β}_{jk}^{( 2 )} ) . \qquad ( 19 )$$

For illustration purposes, solving the optimization problem can involve performing iterative adjustments of the weight vectors w of the neural network model. The weight vectors w of the neural network model can be iteratively adjusted so that the value of the modified loss function \tilde{L}(w) in a current iteration is smaller than the value of the modified loss function in an earlier iteration. The iteration of these adjustments can terminate based on one or more conditions no longer being satisfied. For example, the iteration adjustments can stop if the decrease in the values of the modified loss function in two adjacent iterations is no more than a threshold value. The training may also be terminated if the maximum number of iterations is reached.

At block 312, the process involves the network training server 110 examining outputs of the numerical algorithm used to solve the optimization problem and determining the adjustments to the hyperparameters based on the outputs. For example, the outputs of the numerical algorithm can include the modified loss \tilde{L}(w) as defined in equation (13), the loss L(w), the number of negative paths, and the minimum path value. A path is “negative” if the sum in equation (7) is negative. The “minimum path value” can be defined as the minimum value over all the paths min_{p,j,k}Σᵢ [symbol] ᵢₚβᵢⱼ⁽¹⁾βⱼₖ⁽²⁾δₖ. In some examples, if the modified loss \tilde{L}(w) is below a threshold value and the number of negative paths is 0, then no further adjustments to the hyperparameters are to be made since the model is monotonic in each factor Fₚ. If the number of negative paths is 0 and the loss L(w) was declining during iterations of the numerical algorithm, then the maximum number of training iterations may be increased, while all other hyperparameters are held constant. In this case, the numerical algorithm may resume training from the weight vector w of a previous iteration.

If the loss L(w) of the neural network is larger than a threshold loss function value and the number of negative paths is 0, then the hyperparameter λ or α₁ may be decreased to ensure that the modified loss \tilde{L}(w) places more emphasis on L(w) than the LSE penalty. In such cases, a previous iteration of the weight vector w may not be useful to resume training and the weight vector w can be re-initialized. As another example, if the loss L(w) of the neural network is below the threshold and the number of negative paths is larger than 0, then the hyperparameter λ or α₁ may be increased to ensure that the model is monotonic in each factor Fₚ. These hyperparameter adjustments are for illustration purposes and should not be construed as limiting. Various other ways of adjusting the hyperparameters based on the outputs of the training process can be utilized.

At block 314, the process 300 involves the network training server 110 determining whether one or more hyperparameters need to be adjusted based on the analysis at block 312. If at least one hyperparameter needs to be adjusted, the network training server 110 can adjust, at block 316, the hyperparameters according to the hyperparameter adjustment determined at block 312. Using the adjusted hyperparameters, the network training server 110 can resume the training process at block 310 based on the weight vector w determined in the last iteration or restart the training use the newly initialized weight vector w. If, at block 312, it is determined that no adjustments need to be made to the hyperparameters, the neural network is monotonic in each factor Fₚ and the process 300 involves the network training server 110 outputting the neural network at block 318. The network training server 110 can also record the optimized weight vector w* for use by the neural network model to perform a prediction based on future input predictor variables.

Because the modified loss function \tilde{L}(w) can be a non-concave function, the randomly selected initial values of the hyperparameters, such as the Lagrangian multiplier λ, could, in some cases, cause the solution to the optimization problem in equation (13) to be a local optimum instead of a global optimum. Some aspects can address this issue by randomly selecting the initial values of one or more hyperparameters and repeating the above process with different initial values of these hyperparameters. For example, process 300 could include another block (not shown in FIG. 3) to determine if additional rounds of the training process are to be performed. If so, blocks 310 to 316 can be employed to train the model and tune the values of the hyperparameters based on their respective different initial values. In these aspects, an optimized weight vector can be selected from the results of the multiple rounds of optimization, for example, by selecting a w* resulting in the smallest value of the loss function L(w) and satisfying the path constraint. By selecting the optimized weight factor w*, the neural network can be utilized to predict an output risk indicator based on input predictor variables as explained above with regard to FIG. 2.

Below is another example to construct a neural network that is monotonically constrained in each common factor. This example can be used instead of or in addition to the Lagrangian penalty method approach described above. Returning to Eqn. (7), which can be re-written as

$${\sum }_{i} {ℓ}_{ip} {β}_{ij}^{( 1 )} {β}_{jk}^{( 2 )} {δ}_{k} = {β}_{jk}^{( 2 )} {δ}_{k} {\sum }_{i = 1}^{n} {ℓ}_{ip} {β}_{ij}^{( 1 )} \geq 0 , ∀ j , k . \qquad ( 20 )$$

When training the neural network to minimize the loss function L(w), it is sufficient to ensure βⱼₖ⁽²⁾≥0, δₖ≥0, and Σᵢ₌₁ⁿ [symbol] ᵢₚβᵢⱼ⁽¹⁾≥0 for every j=1, k=1, . . . , K, and p=1, . . . , q. This will ensure that the neural network risk indicator score is positive monotonic in each common factor Fₚ. The first two constraints can be enforced after each training iteration of the neural network by setting βⱼₖ⁽²⁾=0 whenever βⱼₖ⁽²⁾<0 and setting δₖ=0 whenever δₖ<0. So Eqn. (7) reduces to the following constraint

$${\sum }_{i = 1}^{n} {ℓ}_{ip} {β}_{ij}^{1} \geq 0 , ∀ p = 1 , … , q , j = 1 , … , M . \qquad ( 21 )$$

Since the constraint equation (21) does not depend on the bias weights, β⁽¹⁾ can be used to represent the weight matrix with bias terms removed for ease of notation. Since L=[ [symbol] ᵢₚ] is the fixed n×q matrix of loading coefficients, Eqn. (21) is a linear inequality constraint on the vector β_{·j}⁽¹⁾ for each j=1, . . . , M, where β_{·j}⁽¹⁾ represents the n×1 matrix of non-bias weights comprising the j^{th} column of β⁽¹⁾. If L^{T}β_{·j}¹≥0_{q×1}, where 0_{q×1} is the q×1 zero matrix and the inequality “≥” represents an element-wise inequality, then Eqn. (21) holds.

The problem becomes identifying β⁽¹⁾ such that L^{T}β_{·j}¹≥0_{q×1} for every j. To do so, β⁽¹⁾ can be decomposed as β⁽¹⁾=Cα, where C is an n×n matrix and α is an n×M vector, so that the first q rows of α have non-negativity constraints while the remaining n−q rows of α are unconstrained. C can be constructed to satisfy the equation L^{T}C=[I_{q×q}|0_{q×(n-q)}]. As such, C is a transform matrix that changes the basis of the parameter space.

In one example, C can be determined as follows. The rank of L^{T} is at most q<n. The rank of L^{T} is no less than q otherwise it would indicate collinearity of the factors. Therefore the rank of L^{T} can be assumed to be q. To construct C, the following steps can be performed:
1. Perform singular value decomposition to represent L^{T} as UΣV^{T}, where U is an q×q orthogonal matrix, V is an n×n orthogonal matrix, and Σ is an q×n rectangular diagonal matrix with non-negative diagonal entries in decreasing order of magnitude.
2. Compute the pseudo inverse L^{T+} of L^{T} as VΣ⁺U^{T}, where Σ⁺ is obtained by inverting the non-zero elements of E.
3. Set the first q columns of C to L^{T+}.
4. Set the remaining n−q columns of C to the last n−q columns of V.

During the training of the neural network, αᵢⱼ can be set to 0 whenever αᵢⱼ<0, for each i=1, . . . , q and each j=1, . . . , M. Because non-negative constraints are imposed on the first q rows of a while the remaining n−q rows of a are unconstrained, by setting negative αᵢⱼ to 0 for each i=1, . . . , q and each j=1, . . . , M, the following can be achieved:

$${L}^{T} {β}_{\cdot j}^{1} = {L}^{T} C {α}_{\cdot j} = [ {I}_{q \times q} \vert {0}_{q \times ( n - q )} ] {α}_{\cdot j} = [ \begin{matrix}{α}_{1 j} \\ ⋮ \\ {α}_{qj}\end{matrix} ] \geq {0}_{q \times 1} , \qquad ( 22 )$$

This ensures that Eqn. (21) holds for every j and every p.

The above process ignored the bias weights of β¹ for ease of notation. when the bias weights are included, a new 1×(n+1) training vector W can be defined as W=[1 ZC]. Based on Eqn. (2), the following can be derived:

$${H}_{j}^{( 1 )} = φ ( [ \begin{matrix}1 & Z\end{matrix} ] {β}_{\cdot j}^{( 1 )} ) = φ ( {β}_{0 j}^{( 1 )} + ZC {α}_{\cdot j} ) = φ ( W [ \begin{matrix}{β}_{0 j}^{1} \\ {α}_{\cdot j}\end{matrix} ] ) . \qquad ( 23 )$$

Using the above example method, the training process of the neural network can be summarized as follows. The network training server 110 computes the C as described above. Based on the computed C, the network training server 110 modifies the training data Z to be W=ZC. The network training server 110 can train the neural network to minimize the loss function L(w) by changing w using any training algorithm, such as the backpropagation algorithm. As described above, the weight vector w includes all the weights in the neural network, e.g. β⁽¹⁾, β⁽²⁾, and δ. It should be understood that because the training data becomes W (instead of Z), the various weights β⁽¹⁾, β⁽²⁾, and δ determined using the training algorithm are different from the weights determined using the method described above with respect to FIG. 3 where the training data Z is used as input, although they are denoted by the same notations β⁽¹⁾, β⁽²⁾, and δ.

In each iteration of the training, the risk training server 110 places non-negative constraints on the first q non-bias rows of the obtained first weight matrix β⁽¹⁾ by setting any negative weight to zero during training and keeping the bias row and remaining n−q rows unconstrained. The first q non-bias rows of the obtained first weight matrix β⁽¹⁾ include the weights of connections between the first q input nodes of W to the nodes in the first hidden layer of the neural network. The risk training server 110 further places non-negative constraints on each non-bias row in the obtained second weight matrix β⁽²⁾ by setting any negative weight to zero during training while keeping the bias row unconstrained. Likewise, the network training server 110 places non-negative constraints on each non-bias row in the obtained output weight matrix δ by setting any negative weight to zero during training and keeping the bias row unconstrained. By using this training method, no hyperparameters, such as the Lagrangian multiplier λ in Eqn. (1), are introduced. As a result, the training of the neural network does not involve steps such as the loop for adjusting the hyperparameters of the model in block 316 of FIG. 3, and thus has a lower computational complexity.

### Example Factor Analysis

As described above, training the monotonic neural network model includes a factor analysis process to determine a factor loading matrix L of dimension n×q where n is the number of independent variables in the model and q is the number of factors, q<n. According to the model assumptions Z=LF+ε where Z is the vector of n standardized independent variables, F is a vector of q factor values, and ε a vector of n independent random variables with mean zero.

In the monotonic neural network model, the risk indicator Y is monotonic in the factor values F. This enables the model to produce explanatory data for model predictions by utilizing the “points below max” method as explained below; reporting the score increase that would be obtained if each factor in turn was replaced with its optimal value. For this approach to result in an interpretable model, the factors should be interpretable and have a strong correlation with the independent variables. The interpretability of the factors is increased when the loading matrix is sparse. To create sparse factor loading matrices, the following two example approaches can be utilized.

In one example, to discover sparse factor loading matrices, an exploratory analysis can be carried out to determine a likely shape of the sparse matrix, followed by a confirmatory analysis to fit the sparse matrix and assess the statistical validity of the sparsity assumptions. The following example approach can be employed:
1. Use an expectation-maximization (EM) algorithm to fit a full factor loading matrix.
2. Use rotations, such as varimax rotation, to produce an equivalent loading matrix that has a small number of large loadings. Factor loadings are determined only up to orthonormal rotation of the factor space. This process finds a rotation that maximizes the sum of the variances of the squared loadings. This should result in a factor loading matrix with a small number of large loadings and a large number of loading that are close to zero.
3. Hypothesize that the smaller loadings are in fact equal to zero, and test the hypothesis by fitting a confirmatory factor model with those loadings constrained to zero. Statistical tests such as a likelihood-ratio test for nested models can be used to assess the sparsity hypothesis.
   The confirmatory step (step 3 above) may need to be repeated with different subsets of factor loadings constrained to zero, and the above entire method may be repeated for different numbers of factors q.

In another example, a regularized factor analysis is performed. Regularized factor analysis uses a penalty term, such as an L1 term or a least absolute shrinkage and selection operator (LASSO) term to shrink some factor loadings to zero. To better describe the regularized factor analysis, non-regularized factor analysis is presented first. As discussed above, the factor decomposition leads to Z=LF+ε, where Z is the vector of n standardized independent variables, F is a vector of q factor values and ε is a vector of n independent random variables with mean zero. Assume the factors F are independent and identically distributed (IID) following a Gaussian distribution N(0,1) and ε follows a multinomial Gaussian distribution with diagonal covariance matrix IP.

For non-regularized factor analysis, maximum likelihood estimation can be used to fit the values of L, F and Ψ. In this analysis, the complete-data negative log-likelihood with respect to the parameter values can be minimized which is given by the formula:

$$- log p ( Z , F \vert L , Ψ ) = - {\sum }_{r = 1}^{N} \{ log p ( {z}_{i} \vert {f}_{i} ) + log p ( {f}_{i} ) \} \qquad ( 24 )$$

where zᵣ and fᵣ denote the values of Z and F respectively for the r^{th} training data record and N is the total number of training data records. The optimization can be achieved with stochastic gradient descent. Alternatively, or additionally, an expectation-maximization (EM) algorithm may be used. For example, given starting values of L, F and Ψ, the expectation step (E-step) and maximization step (M-step) of the EM algorithm can be alternated as follows:

E-Step

E(fᵣ)=GL^{T}Ψ⁻¹zᵣ (25)

E(fᵣfᵣ^{T})=G+E(fᵣ)E(fᵣ)^{T} (26)

where G=(I+L^{T} Ψ⁻¹L)⁻¹ and the mean of Z is omitted since it is zero.

M-Step

$${L}_{new} = {[ {\sum }_{r} {z}_{r} {E ( {f}_{r} )}^{T} ] [ {\sum }_{r} E ( {f}_{r} {f}_{r}^{T} ) ]}^{- 1} \qquad ( 27 )$$

$${Ψ}_{new} = diag \{ S - {L}_{new} \frac{1}{N} {\sum }_{r = 1}^{N} E ( {f}_{r} ) {z}_{r}^{T} \} \qquad ( 28 )$$

where S is the data covariance matrix of Z and the diag operator sets all the non-diagonal elements of the matrix argument to zero. Successive application of E- and M-steps is guaranteed to increase log-likelihood and the process can be stopped when convergence is achieved, such as when the increase per iteration falls below a threshold.

Note that neither stochastic gradient descent nor the EM algorithm guarantee that a globally optimal solution will be found, and so multiple randomly selected starting values may be tested for the parameters.

For regularized factor analysis, a penalty term can be introduced into the quantity to be minimized. The penalty term used can be a multiple of the L1 norm of the factor loading matrix L. This leads to the following loss function:

−Σᵣ₌₁^{N}{log p(zᵣ|fᵣ)+log p(fᵣ)}+α∥L∥₁ (29)

The regularization parameter α>0 determines the relative weighting of the log-likelihood and penalty terms. Higher values of a apply more shrinkage to the elements of L. A value of zero for a corresponds to the non-regularized solution.

The above optimization problem can be solved with a modified EM algorithm, with steps as follows:

E-Step

The E-step calculates the expected values of the sufficient statistics for F, that is E(fᵢ) and E(fᵢfᵢ^{T}), given current values of the parameters L and Ψ. Note that this is independent of the penalty term α∥L∥₁ so the formula is identical to the non-regularized case:

E(fᵣ)=GL^{T}Ψ⁻¹zᵣ (30)

E(fᵣfᵣ^{T})=G+E(fᵣ)E(fᵣ)^{T} (31)

where G=(I+L^{T} Ψ⁻¹L)⁻¹ and the mean of Z is omitted since it is zero.

M-Step

The M-step is configured to minimize the expected loss function

E[−log p(Z,F|L,Ψ)+α∥L∥₁]=E[−log p(Z,F|L,Ψ)]+α∥L∥₁ (32)

with respect to L and Ψ, given the current values of the sufficient statistics E(fᵣ) and E(fᵣfᵣ^{T}). Noting that the M-step in the unregularized case is equivalent to ordinary least squares regression of Z on F. It can be replaced with LASSO regression of Z on F, so any solution for LASSO regression making use of the sufficient statistics for F may be applied. LASSO regression does not generally admit a closed-form solution, but it does in the case that the independent variables are orthonormal (uncorrelated with unit variance). Orthonormality of the factors F is an assumption of the regularized factor analysis model, so the closed-form solution can be obtained as:

$${L}_{new}^{OLS} = {[ {\sum }_{r} {z}_{r} {E ( {f}_{r} )}^{T} ] [ {\sum }_{r} E ( {f}_{r} {f}_{r}^{T} ) ]}^{- 1} \qquad ( 33 )$$

$${L}_{new} = {Sh}_{α} ( {L}_{new}^{OLS} ) \qquad ( 34 )$$

$${Ψ}_{new} = diag \{ S - {L}_{new} \frac{1}{N} {\sum }_{r = 1}^{N} E ( {f}_{r} ) {z}_{r}^{T} \} \qquad ( 35 )$$

where S is the data covariance matrix of Z and the diag operator sets all the non-diagonal elements of the matrix argument to zero. Here, the function Sh_{α} is a soft-thresholding function applied to L term-wise as follows:

$$\begin{matrix}{Sh}_{α} ( {L}_{nq} ) = {L}_{nq} max ( 0 , 1 - \frac{α}{\vert {L}_{nq} \vert} ) \\ = sign ( {L}_{nq} ) max ( 0 , \vert {L}_{nq} \vert - α )\end{matrix} \qquad ( 36 )$$

This has the effect of translating the entries of L towards zero by α, making them equal to zero if they are close enough.

Similar to the non-regularized case, the iteration may be stopped when a convergence criterion is achieved. Multiple starting values may be tested for the parameters to increase the chance of reaching a globally optimal solution.

The value of the shrinkage parameter α determines how many terms of the loading matrix L will be shrunk to zero. A sparser loading matrix leads to a more interpretable factor decomposition, but at the expense of the level of correlation between the factors and independent variables.

For the factor analysis model to be consistent, the factor loadings from a (regularized or un-regularized) model should have absolute values less than one, otherwise the variance of the corresponding coordinates of Z would exceed one, and Z has been standardized to have unit variance. As such, the values of α may be taken between zero and one. An appropriate value of α may also be determined by balancing the number of factors q and the shrinkage parameter α to achieve a trade-off between interpretability and statistical fit of the factor model.

Similar to the confirmatory factor analysis described above, after an optimal value of α is achieved, un-regularized constrained factor analysis can be performed, with zero constraints applied to those elements of L that were shrunk to zero in the regularized model. This will produce better-fitting estimates for the non-zero factor loadings given the constraints.

Examples of Computing Explanation Data with Neural Network

To generate explanatory data such as reason codes, any standard reason code technique can be utilized to compute the impact of factor Fₚ on the risk indicator. For example, Eqn. (37) generalizes a “points below max” approach that can be used to determine the reason code:

g(F₁, . . . ,Fₚ*, . . . ,F_{q},ε₁, . . . ,εₙ)−g(F₁, . . . ,Fₚ, . . . F_{q},ε₁, . . . ,εₙ). (37)

Here, g(·) denotes the function or model for determining the risk indicator Y using the factors as inputs and F*ₚ is the value of Fₚ that maximizes the risk indicator. Since the factors are unobservable latent variables, they need to be estimated. Denote the estimates, called factor scores, by \hat{F}ₚ and \hat{ε}ᵢ, and \hat{ε}i=\hat{ε}i|_{\hat{F}p}=Zᵢ−L\hat{F}. Any known techniques for estimating the factor scores \hat{F}ₚ can be utilized. Let \hat{F}ₚ* denote the location of the factor score \hat{F}ₚ that maximizes the risk indicator g(\hat{F}₁, . . . , \hat{F}_{q}, \hat{ε}₁, . . . , \hat{ε}n). Since g is monotonic in the common factors, \hat{F}ₚ* will be the right or left endpoint of the domain of \hat{F}ₚ, depending on whether it is a positive or negative behavior factor. Owing to the fact that the factor scores \hat{F}ₚ are linear inputs of the input X attributes, \hat{F}ₚ* will correspond to a right or left endpoint of each Xᵢ that loads on Fₚ (i.e. each Xᵢ where [symbol] ᵢₚ is non-zero). Therefore, Xᵢ=Xᵢ* and εᵢ|_{\hat{F}1, . . . , \hat{F}p*, . . . , \hat{F}q}=Zᵢ*−Σ_{k≠p} [symbol] ᵢₚ\hat{F}ₖ− [symbol] ᵢₚ\hat{F}ₚ* for every attribute X that loads on the factor \hat{F}ₚ. Thus at \hat{F}ₚ=\hat{F}ₚ*, Zᵢ=L\hat{F}+\hat{ε}ᵢ=Σ_{k≠p} [symbol] ᵢₚ\hat{F}ₖ−ᵢₚ\hat{F}ₚ*+Zᵢ*−Σ_{k·p} [symbol] ik\hat{F}ₖ− [symbol] ᵢₚ\hat{F}ₚ*=Zᵢ*. Applying the “points below max” equation (37), the following can be obtained:

g(\hat{F}₁, . . . ,\hat{F}ₚ*, . . . ,\hat{F}_{q},\hat{ε}₁|_{\hat{F}1, . . . ,\hat{F}p*, . . . ,\hat{F}q}, . . . εₙ|_{\hat{F}1, . . . ,\hat{F}p*, . . . ,\hat{F}q})−g(\hat{F}₁, . . . ,\hat{F}ₚ, . . . ,\hat{F}_{q},\hat{ε}₁|_{\hat{F}1, . . . ,\hat{F}p*, . . . ,\hat{F}q}, . . . ,\hat{ε}ₙ|_{\hat{F}1, . . . ,\hat{F}p*, . . . ,\hat{F}q}) (38)

In the case that Fₚ is a trivial factor (i.e. only one non-zero [symbol] ᵢₚ is non-zero), the key factor equation (38) becomes

g(\hat{F}₁, . . . ,\hat{F}ₚ*, . . . ,\hat{F}_{q},\hat{ε}₁|_{\hat{F}1, . . . ,\hat{F}p*, . . . ,\hat{F}q}, . . . ,εₙ|_{\hat{F}1, . . . ,\hat{F}p*, . . . ,\hat{F}q})−g(\hat{F}₁, . . . ,\hat{F}ₚ, . . . ,\hat{F}_{q},\hat{ε}₁|_{\hat{F}1, . . . ,\hat{F}p*, . . . ,\hat{F}q}, . . . ,\hat{ε}ₙ|_{\hat{F}1, . . . ,\hat{F}p*, . . . ,\hat{F}q})=f(X₁, . . . ,Xᵢ*, . . . ,Xₙ)−f(X₁, . . . ,Xᵢ, . . . ,Xₙ). (39)

Here f(·) represents the model used to determine the risk indicator by using predictor variables Xᵢ as inputs. If multiple predictor variables load on the factor Fₚ, for example, three input variables Xᵣ, Xₛ, and Xₜ, the key factor equation (38) becomes:

g(\hat{F}₁, . . . ,\hat{F}ₚ*, . . . ,\hat{F}_{q},\hat{ε}₁|_{\hat{F}1, . . . ,\hat{F}p*, . . . ,\hat{F}q}, . . . ,εₙ|_{\hat{F}1, . . . ,\hat{F}p*, . . . ,\hat{F}q})−g(\hat{F}₁, . . . ,\hat{F}ₚ, . . . ,\hat{F}_{q},\hat{ε}₁|_{\hat{F}1, . . . ,\hat{F}p*, . . . ,\hat{F}q}, . . . ,\hat{ε}ₙ|_{\hat{F}1, . . . ,\hat{F}p*, . . . ,\hat{F}q})=f(X₁, . . . ,Xᵣ*, . . . ,Xₛ*, . . . ,Xₜ*, . . . ,Xₙ)−f(X₁, . . . ,Xᵣ, . . . ,Xₛ, . . . ,Xₜ, . . . ,Xₙ). (40)

Equation (40) can be used to determine the impact of the factor Fₚ on the neural network model. Moreover, the key factor equation (40) accounts for the fact that, for multicollinear attributes Xᵣ, Xₛ, and Xₜ, these attributes cannot move independently of one another and must move together. This is powerful in that it does not favor input attributes that are orthogonal to the rest of the data and provides a much better explanation of the key factors impacting a risk indicator.

To generate the reason code, for each factor Fₚ, the points below max may be computed by applying equation (38). Two examples of application were provided in equations (39) and (40). The resulting points are sorted in descending order and one or more common reason codes can be generated for predictor variables loading on the same factor Fₚ having one of the highest points. Other similar explanation methods may be applied to rank the significance of each factor Fₚ on the neural network model and to generate the reason code.

### Example of Computing System for Machine-Learning Operations

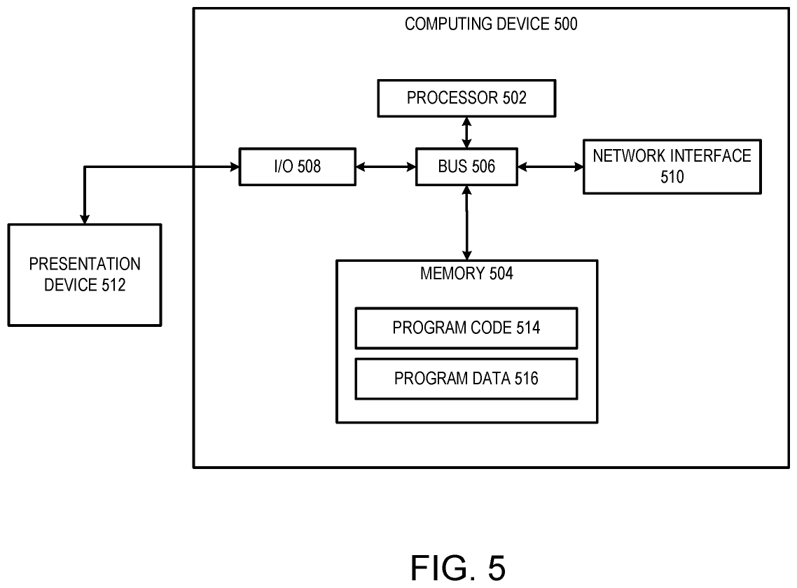

Any suitable computing system or group of computing systems can be used to perform the operations for the machine-learning operations described herein. For example, FIG. 5 is a block diagram depicting an example of a computing device 500, which can be used to implement the risk assessment server 118 or the network training server 110. The computing device 500 can include various devices for communicating with other devices in the operating environment 100, as described with respect to FIG. 1. The computing device 500 can include various devices for performing one or more transformation operations described above with respect to FIGS. 1-4.

The computing device 500 can include a processor 502 that is communicatively coupled to a memory 504. The processor 502 executes computer-executable program code stored in the memory 504, accesses information stored in the memory 504, or both. Program code may include machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing or receiving information, data, arguments, parameters, or memory contents. Information, arguments, parameters, data, etc. may be passed, forwarded, or transmitted via any suitable means including memory sharing, message passing, token passing, network transmission, among others.

Examples of a processor 502 include a microprocessor, an application-specific integrated circuit, a field-programmable gate array, or any other suitable processing device. The processor 502 can include any number of processing devices, including one. The processor 502 can include or communicate with a memory 504. The memory 504 stores program code that, when executed by the processor 502, causes the processor to perform the operations described in this disclosure.

The memory 504 can include any suitable non-transitory computer-readable medium. The computer-readable medium can include any electronic, optical, magnetic, or other storage device capable of providing a processor with computer-readable program code or other program code. Non-limiting examples of a computer-readable medium include a magnetic disk, memory chip, optical storage, flash memory, storage class memory, ROM, RAM, an ASIC, magnetic storage, or any other medium from which a computer processor can read and execute program code. The program code may include processor-specific program code generated by a compiler or an interpreter from code written in any suitable computer-programming language. Examples of suitable programming language include Hadoop, C, C++, C #, Visual Basic, Java, Python, Perl, JavaScript, ActionScript, etc.

The computing device 500 may also include a number of external or internal devices such as input or output devices. For example, the computing device 500 is shown with an input/output interface 508 that can receive input from input devices or provide output to output devices. A bus 506 can also be included in the computing device 500. The bus 506 can communicatively couple one or more components of the computing device 500.

The computing device 500 can execute program code 514 that includes the risk assessment application 114 and/or the network training application 112. The program code 514 for the risk assessment application 114 and/or the network training application 112 may be resident in any suitable computer-readable medium and may be executed on any suitable processing device. For example, as depicted in FIG. 5, the program code 514 for the risk assessment application 114 and/or the network training application 112 can reside in the memory 504 at the computing device 500 along with the program data 516 associated with the program code 514, such as the predictor variables 124 and/or the neural network training samples 126. Executing the risk assessment application 114 or the network training application 112 can configure the processor 502 to perform the operations described herein.

In some aspects, the computing device 500 can include one or more output devices. One example of an output device is the network interface device 510 depicted in FIG. 5. A network interface device 510 can include any device or group of devices suitable for establishing a wired or wireless data connection to one or more data networks described herein. Non-limiting examples of the network interface device 510 include an Ethernet network adapter, a modem, etc.

Another example of an output device is the presentation device 512 depicted in FIG. 5. A presentation device 512 can include any device or group of devices suitable for providing visual, auditory, or other suitable sensory output. Non-limiting examples of the presentation device 512 include a touchscreen, a monitor, a speaker, a separate mobile computing device, etc. In some aspects, the presentation device 512 can include a remote client-computing device that communicates with the computing device 500 using one or more data networks described herein. In other aspects, the presentation device 512 can be omitted.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

1. A method that includes one or more processing devices performing operations comprising:
determining, using a neural network model trained using a training process, a risk indicator for a target entity from predictor variables associated with the target entity, wherein the risk indicator indicates a level of risk associated with the target entity, wherein the training process includes operations comprising:
accessing training vectors having elements representing training predictor variables and training outputs, wherein a particular training vector comprises particular values for the predictor variables, respectively, and a particular training output corresponding to the particular values,
obtaining loading coefficients of common factors of the training predictor variables in the training vectors, and
performing iterative adjustments of parameters of the neural network model to minimize a loss function of the neural network model subject to a path constraint, the path constraint requiring monotonicity in a relationship between (i) values of each common factor of the predictor variables from the training vectors and (ii) the training outputs of the training vectors, the relationship defined by the loading coefficients and the parameters of the neural network model; and
generating, for the target entity, explanatory data indicating relationships between changes in the risk indicator and changes in at least some of the common factors; and
transmitting, to a remote computing device, a responsive message including at least the risk indicator for use in controlling access of the target entity to one or more interactive computing environments.

2. The method of claim 1, wherein the neural network model comprises at least an input layer, one or more hidden layers, and an output layer, and wherein the parameters for the neural network model comprise weights of connections among the input layer, the one or more hidden layers, and the output layer.

3. The method of claim 2, wherein the training process includes further operations comprising, prior to performing the iterative adjustments of the parameters of the neural network model:
calculating a transform matrix by decomposing a loading matrix formed by the loading coefficients of the common factors of the training predictor variables; and
transforming the training predictor variables by applying the transform matrix to the training predictor variables.

4. The method of claim 3, wherein an iterative adjustment comprises setting the weights of connections among the one or more hidden layers and the output layer that are negative to zero.

5. The method of claim 4, wherein an iterative adjustment further comprises:
identifying a subset of the weights of connections between the input layer and a first hidden layer of the one or more hidden layers; and
setting a negative weight in the subset of the weights of connections to zero.

6. The method of claim 2, wherein an iterative adjustment comprises adjusting the parameters of the neural network model so that a value of a modified loss function in a current iteration is smaller than the value of the modified loss function in another iteration, and wherein the modified loss function comprises the loss function of the neural network model and the path constraint.

7. The method of claim 6, wherein the path constraint is added into the modified loss function through a hyperparameter, and wherein training the neural network model further comprises:
setting the hyperparameter to a random initial value prior to performing the iterative adjustments;
in the iterative adjustment, determining a value of the loss function of the neural network model and a number of paths violating the path constraint based on a particular set of parameter values associated with the random initial value of the hyperparameter;
determining that the value of the loss function is greater than a threshold loss function value and that the number of paths violating the path constraint is zero;
updating the hyperparameter by decrementing the value of the hyperparameter; and
determining an additional set of parameter values for the neural network model based on the updated hyperparameter.

8. The method of claim 7, wherein training the neural network model further comprises:
in the iterative adjustment, determining a value of the loss function of the neural network model and a number of paths violating the path constraint based on the particular set of parameter values associated with the random initial value of the hyperparameter;
determining that the value of the loss function is lower than a threshold loss function value and that the number of paths violating the path constraint is non-zero;
updating the hyperparameter by incrementing the value of the hyperparameter; and
determining a second additional set of parameter values for the neural network model based on the updated hyperparameter.

9. The method of claim 1, wherein obtaining loading coefficients of common factors of the training predictor variables in the training vectors comprises one or more of:
performing factor analysis on the training predictor variables to obtain the loading coefficients of the common factors of the training predictor variables, or
receiving the loading coefficients of the common factors of the training predictor variables.

10. The method of claim 9, wherein performing the factor analysis on the training predictor variables comprises applying an expectation-maximization (EM) algorithm, where a maximization step of the EM algorithm is performed by
applying a least absolute shrinkage and selection operator (LASSO) regression on the training predictor variables and the common factors by introducing an L1 norm of a loading matrix formed by the loading coefficients of the common factors to a loss function of the maximization step; and
solving the maximization step by applying a closed-form solution of the LASSO regression.

11. A system comprising:
a processing device; and
a memory device in which instructions executable by the processing device are stored for causing the processing device to:
determine, using a neural network model trained using a training process, a risk indicator for a target entity from predictor variables associated with the target entity, wherein the risk indicator indicates a level of risk associated with the target entity, wherein the training process includes operations comprising:
accessing training vectors having elements representing training predictor variables and training outputs, wherein a particular training vector comprises particular values for the predictor variables, respectively, and a particular training output corresponding to the particular values,
obtaining loading coefficients of common factors of the training predictor variables in the training vectors, and
performing iterative adjustments of parameters of the neural network model to minimize a loss function of the neural network model subject to a path constraint, the path constraint requiring monotonicity in a relationship between (i) values of each common factor of the predictor variables from the training vectors and (ii) the training outputs of the training vectors, the relationship defined by the loading coefficients and the parameters of the neural network model; and
generate, for the target entity, explanatory data indicating relationships between changes in the risk indicator and changes in at least some of the common factors; and
transmit, to a remote computing device, a responsive message including at least the risk indicator.

12. The system of claim 11, wherein the neural network model comprises at least an input layer, one or more hidden layers, and an output layer, and wherein the parameters for the neural network model comprise weights of connections among the input layer, the one or more hidden layers, and the output layer.

13. The system of claim 12, wherein the training process includes further operations comprising, prior to performing the iterative adjustments of the parameters of the neural network model:
calculating a transform matrix by decomposing a loading matrix formed by the loading coefficients of the common factors of the training predictor variables; and
transforming the training predictor variables by applying the transform matrix to the training predictor variables; and
wherein an iterative adjustment comprises setting the weights of connections among the one or more hidden layers and the output layer that are negative to zero.

14. The system of claim 12, wherein one or more of the iterative adjustments comprises adjusting the parameters of the neural network model so that a value of a modified loss function in a current iteration is smaller than the value of the modified loss function in another iteration, and wherein the modified loss function comprises the loss function of the neural network model and the path constraint.

15. The system of claim 11, wherein the loading coefficients of the common factors of the training predictor variables are generated by performing a factor analysis on the training predictor variables comprises applying an expectation-maximization (EM) algorithm, wherein a maximization step of the EM algorithm is performed by:
applying a least absolute shrinkage and selection operator (LASSO) regression on the training predictor variables and the common factors by introducing an L1 norm of a loading matrix formed by the loading coefficients of the common factors to a loss function of the maximization step; and
solving the maximization step by applying a closed-form solution of the LASSO regression.

16. A non-transitory computer-readable storage medium having program code that is executable by a processor device to cause a computing device to perform operations, the operations comprising:
determining, using a neural network model trained using a training process, a risk indicator for a target entity from predictor variables associated with the target entity, wherein the risk indicator indicates a level of risk associated with the target entity, wherein the training process includes operations comprising:
accessing training vectors having elements representing training predictor variables and training outputs, wherein a particular training vector comprises particular values for the predictor variables, respectively, and a particular training output corresponding to the particular values,
obtaining loading coefficients of common factors of the training predictor variables in the training vectors, and
performing iterative adjustments of parameters of the neural network model to minimize a loss function of the neural network model subject to a path constraint, the path constraint requiring monotonicity in a relationship between (i) values of each common factor of the predictor variables from the training vectors and (ii) the training outputs of the training vectors, the relationship defined by the loading coefficients and the parameters of the neural network model; and
generating, for the target entity, explanatory data indicating relationships between changes in the risk indicator and changes in at least some of the common factors; and
transmitting, to a remote computing device, a responsive message including at least the risk indicator.

17. The non-transitory computer-readable storage medium of claim 16, wherein the neural network model comprises at least an input layer, one or more hidden layers, and an output layer, and wherein the parameters for the neural network model comprise weights of connections among the input layer, the one or more hidden layers, and the output layer.

18. The non-transitory computer-readable storage medium of claim 17, wherein the training process includes further operations comprising, prior to performing the iterative adjustments of the parameters of the neural network model:
calculating a transform matrix by decomposing a loading matrix formed by the loading coefficients of the common factors of the training predictor variables; and
transforming the training predictor variables by applying the transform matrix to the training predictor variables; and
wherein an iterative adjustment comprises setting the weights of connections among the one or more hidden layers and the output layer that are negative to zero.

19. The non-transitory computer-readable storage medium of claim 17, wherein one or more of the iterative adjustments comprises adjusting the parameters of the neural network model so that a value of a modified loss function in a current iteration is smaller than the value of the modified loss function in another iteration, and wherein the modified loss function comprises the loss function of the neural network model and the path constraint.

20. The non-transitory computer-readable storage medium of claim 16, wherein the loading coefficients of the common factors of the training predictor variables are generated by performing a factor analysis on the training predictor variables comprises applying an expectation-maximization (EM) algorithm, wherein a maximization step of the EM algorithm is performed by:
applying a least absolute shrinkage and selection operator (LASSO) regression on the training predictor variables and the common factors by introducing an L1 norm of a loading matrix formed by the loading coefficients of the common factors to a loss function of the maximization step; and
solving the maximization step by applying a closed-form solution of the LASSO regression.
